(19) United States
(12) Patent Application Publication
(10) Pub. No.: US 2006/0117303 A1
(43) Pub. Date: Jun. 1, 2006

(54) Method of simplifying & automating enhanced optimized decision making under uncertainty

(76) Inventor: Gerard H. Gizinski, Wilton, CT (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/996,926

(22) Filed: Nov. 24, 2004

(51) Int. Cl. G06F 9/45

(52) U.S. Cl. 717/136; 717/114

(57) ABSTRACT

Many business problems involve too many complex and interacting variables for a person to solve them, unassisted. Linear programming, statistical and probability analyses provide effective tools for solving such problems, but until now, use of these tools has not been practical for persons without extensive mathematical training. The present invention provides an understandable user interface to these tools, enabling even mathematically unsophisticated users to effectively solve complex problems. The invention also incorporates sensitivity analyses, thereby permitting the user to explore how changes in input data would affect the results of the program calculations. In addition to a data-input program module, respective program modules are disclosed for managing a company product line, a securities portfolio, and a short-selling portfolio.

Cross-reference to related patents, the disclosures of which are hereby incorporated by reference: U.S. Pat. Nos. 5,469,538 & 5,526,475, RAZDOW, currently owned by MathSoft Inc. of Cambridge, Mass., USA. MATHCAD is a trademark (US Reg. #1,457,219) of MathSoft, Inc.; EXCEL, SOLVER and VISUAL BASIC are trademarks of Microsoft Corp. of Redmond, Wash.

### COMPUTER PROGRAM LISTING APPENDIX

This application includes a computer program listing appendix in accordance with 37 CFR 1.96(c), consisting of 20 pages, the entire content of which is incorporated by reference.

### FIELD OF THE INVENTION

The present invention relates generally to a computer-supported method of solving real-world problems, using linear programming and probability analysis, amongst other methods, and, more particularly, to a user interface which permits even those unfamiliar with these tools to successfully apply these tools to the solution of real-world problems such as managing a business or managing an investment portfolio.

### BACKGROUND

Although computers afford the potential to handle complex problems and sophisticated mathematical procedures, the vast majority of computer users bypass these possibilities.

Information technologists estimate that 80 percent of all personal computer use involves typewriting on word processing or e-mail programs. Generally, only technical specialists, scientists or engineers utilize sophisticated programs peculiar to their respective specialties. Non-specialists have two problems in addressing this deficiency. First, they may, or may not, have any familiarity with the underlying technical area, mathematics, science or engineering. Second, with limited know-how concerning the technical underpinnings, learning to utilize the specialized computer programs represents a difficult task.

Yet, sophisticated solutions to many very important business and personal problems require the computational and data handling possibilities of computers. Large organizations with substantial financial resources can afford to hire technical specialists and experts to build proprietary systems useful to the organization's function. However, even large organizations have a predilection to favor investments in data handling systems over development of computational analytical tools.

Consider statistics and probability theory. Although an airline traveler has orders of magnitude less chance of a fatal encounter in the air than a fatal encounter in an automobile traveling to the airport, most travelers feel more comfortable in a car than a plane. In business, only insurance company actuaries, risk assessors for large companies, quality controllers and research scientists routinely utilize statistics and probability theory.

Mathematical optimization techniques also have specialized roles in business. Petroleum refiners, airlines, livestock feed blenders, distributors, investment firms and corporate treasurers routinely utilize optimization techniques. Refiners and livestock feed blenders use linear programs to minimize input costs of ingredients for product production. Airlines and distributors use optimization to schedule and route transportation equipment such as planes or trucks. Investment firms use non-linear programming to manage stock portfolios or manage cash. Corporate treasuries use optimization to manage the corporate cash. Operators of these programs often lack the expertise to devise the structure and equations required to mathematically formulate a problem solution. Either operations research consultants or technical staff members assist in problem and solution formulation. Specialty program houses sell these optimization programs.

Program installation requires certain fundamental operating coefficients to customize the program for the user organization. Over time, the operating coefficients change, necessitating program updates for the program to remain relevant. The frequency of user updates varies between organizations.

U.S. Pat. No. 6,032,123, JAMESON (February 2002), discloses the use of linear programming and “Monte Carlo simulation” in solving business problems. However, it is not clear how the simulation is performed, nor whether sufficient statistical analyses, of initial results of a program-run, are performed to verify that those results are optimal, or even satisfactory in a real-world context.

US Patent Application Publication 2003/0 046 130-A1 (March 2003), GOLIGHTLY et al., Ser. No. 10/225,093, discloses a system and method for optimization of business operations in a chemical or manufacturing plant. However, it is not clear how the method could be adapted for use in managing investments.

U.S. Pat. No. 5,581,663 (ZLOTIN et al.), U.S. Pat. No. 5,692,233 (GARMAN), U.S. Pat. No. 5,781,430 (TSAI), U.S. Pat. No. 6,031,984 (WALSER), U.S. Pat. No. 6,122,623 (GARMAN), U.S. Pat. No. 6,405,179 (REBANE) and US Patent Application Publications 2002/0,111,780-A1 (SY), 2003/0,004,845-A1 (TAKEDA et al.), 2003/0,083,971-A1 (KAWAMOTO et al.) and 2003/0,148,253-A1 (SACCO et al.) disclose computer-supported methods of managing investments.

However, after reviewing the prior art, it is apparent that there is still a need for an easy-to-use, yet mathematically powerful, method of solving problems which can be applied both to business management problems and to investment management problems.

Expert systems and methods have been created to serve specific problem solution needs. In particular, expert systems cover certain areas of medical diagnosis and investment formulation. However, these systems and methods generally involve Boolean logic, decision trees and data mining that utilize the data handling capabilities of computers rather than sophisticated mathematical treatment.

Thus it can be appreciated that a great need exists in the art, for an improved method, device and system to permit a broad range of users to improve their problem solving and resolution techniques. Such a method, device and system should place minimal or no requirements on users to learn or understand the underlying mathematics, statistics, optimization and expert analysis but should afford access to such capabilities through a simple interface. By avoiding the drawbacks and shortcomings of learning either the underlying mathematics, statistics and optimization techniques or associated data handling and computer programs, users avoid potential mishandling of said programs from either usage based on untimely information or misusage.

Furthermore, it can be appreciated that additional need exists in the art for methods, devices and a system to co-ordinate and record the output of disparate computer programs, analyze the disparate results and utilize the implications of the results in a coordinated, refined expert process. Such methods, devices and system should avoid the manual manipulation and integration that analytical results, from disparate sources such as engineering analysis, statistical analysis or optimization processes, require to synthesize a coherent and vigorous problem solution.

### SUMMARY OF THE INVENTION

Therefore, it is an object of the present invention to provide a method of solving problems, with the assistance of a personal computer, which combines features of linear programming, probability analysis, and expert systems with a simple interface which enables users, who do not necessarily understand the details of these tools, to successfully apply these tools to solve real-world problems. My name for this simple interface is “the Answer Machine.”

In a preferred embodiment, a plurality of software modules are executed, in sequence, to perform the steps of the method. Some of these modules are specially adapted for their application, as described in greater detail below.

In a first step, the program interacts with the user to determine the nature of the problem to be solved and to prompt the user to provide the appropriate kinds and quantities of data. The program reads the data into a matrix or spreadsheet and checks validity of the data.

In the second step, the program performs a statistical analysis of the data including: a Fourier analysis correlation, development of a forecasting regression, forecasts, determination of the median value and standard error (or variability) of the data and conversion of the median and variability into a probability distribution; and places the calculated results in additional cells which represent an extension of the original matrix or spreadsheet.

In the third step, the program installs basic constraint equations and performs a preliminary Linear Programming (LP) analysis of the data to obtain a sensitivity analysis of the LP analysis subject to perturbations in price changes. This sensitivity analysis indicates the “opportunity cost” associated with producing and marketing products without any constraints on the ingredient inputs required to meet forecasted demand in the marketing solution module. For stock purchase (portfolio management) or stock shorting solution modules, the LP sensitivity analysis indicates required price changes to make a stock a likely candidate for either purchase or sale in a “trading range” stock market environment.

In the fourth step, the program iterates LP formulations, solutions and analysis for the various prices indicated by the LP sensitivity analysis of step three to determine the frequency of occurrences of: products in the market mix of the marketing solution module or stocks in the portfolio management or stock shorting solution modules.

In the fifth step, the program uses the probability distribution determined in step three: to set upper and lower demand limits on demand forecasts for products or to compare stock prices with the probability of price increases or decreases within a “trading range” for stock trading.

In the sixth step, the program uses expert analysis in conjunction with the results of step five to: recommend and make adjustments to the marketing/sales budgets for products, install demand constraint equations and solve the LP with the expanded constraints; determine for stocks whether to buy or sell within a trading range or buy or sell with the intent to move beyond the trading range or not to commit to any trade.

### BRIEF FIGURE DESCRIPTION

FIG. 1 schematically illustrates the use of a personal computer to collect data via a global network, to process the data, and to communicate results and solutions;

FIG. 1A is a flowchart showing steps of an interaction between a computer user and an “Answer Machine” program module according to the present invention;

FIGS. 1B & 1C are flowcharts showing steps of “solution” program modules of the present invention which rely upon mathematical functions in the commercially available MATHCAD program described in U.S. Pat. Nos. 5,469,538 and 5,526,475 to perform Fourier regression, correlation, statistical analysis and forecasting;

FIG. 2 is a flowchart illustrating a method of collecting data relating to a proposed or actual product of a business;

FIG. 3 is a flowchart illustrating how to formulate ratios for use in linear programming calculations, such as those typically used in marketing, pricing and gross margin problems;

FIG. 4 is a flowchart of a “Remake” program module for optimizing products, product market segments, product development budgets, and sales/marketing budgets;

FIG. 5 is a flowchart of a “Stkanlzr” program module for optimizing the reward/risk ratio for a stock portfolio; and

FIG. 6 is a flowchart of a “Stkshortr” program module for optimizing short sales of stocks.

FIG. 7A is a flowchart of the PD&ISnlzr module, for product development analysis;

FIG. 7B is a flowchart for restoring PD&ISnlzr, Sheet2, to Original Solution Condition;

FIG. 7C is a flowchart of the PD&ISnlzr module, to evaluate input substitution;

FIG. 7D is a flowchart for restoring PD&ISnlzr, Sheet3, to Original Solution Condition; and

FIG. 8 is a flowchart showing how to output final results from the Stkanlzr or Stkshortr solution modules to a simple spreadsheet, e.g. an EXCEL spreadsheet.

### DETAILED DESCRIPTION

In the following discussion, a reference to a stock index on a North American stock exchange is intended as exemplary only, and investment professionals will understand that the methods described are equally applicable to a stock index compiled in Europe, Asia, or elsewhere, or indeed to an index of securities or other asset values yet to be formulated. A reference to a “stock” is not necessarily limited to a common equity share as it is understood today, because the general principles discussed herein are applicable to preferred shares, bonds, convertible bonds, real estate trust shares and similar exchange-traded interests in income-producing assets.

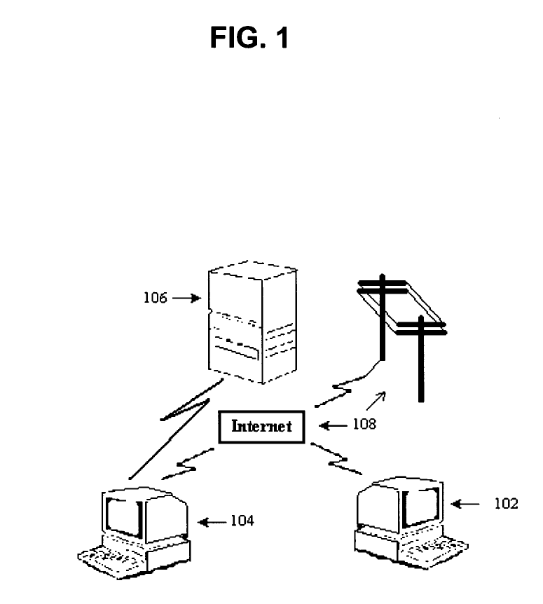

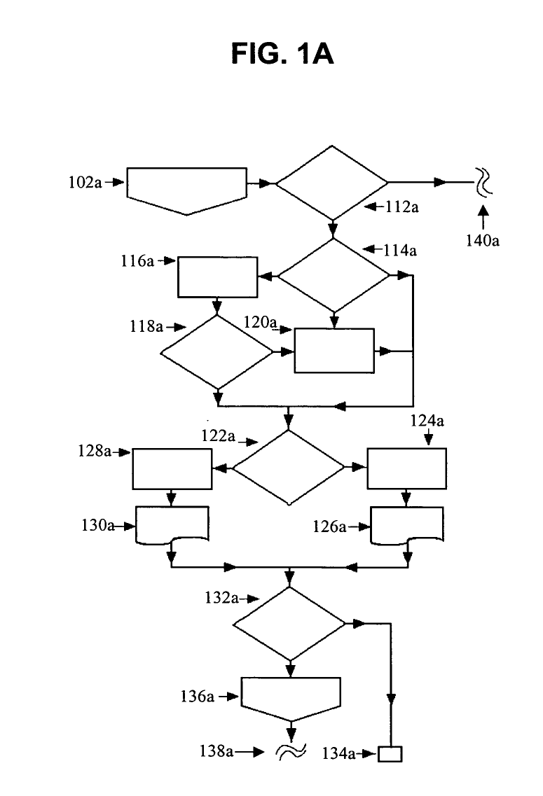

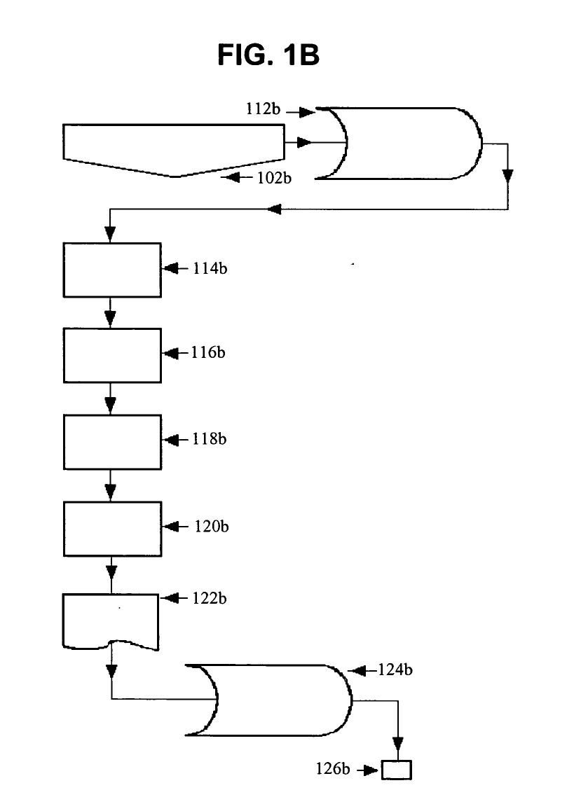

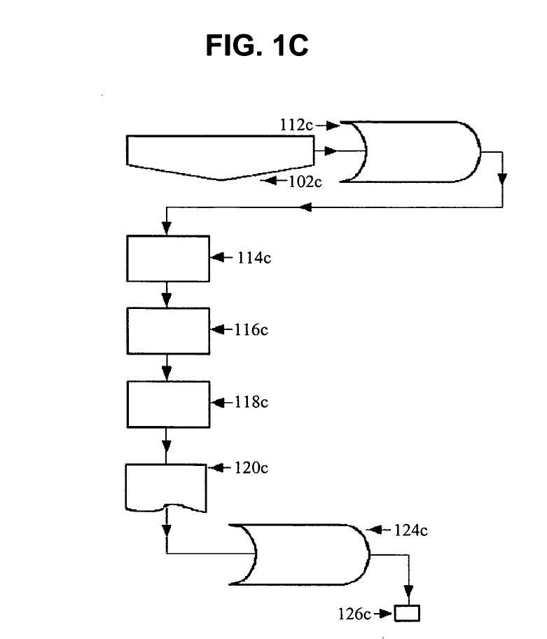

FIG. 1 schematically illustrates that a personal computer 102 can be used to communicate with a second computer 104 or computer server 106 via a wired or wireless network 108. Although a desktop computer with a large monitor is shown for illustration purposes, those of ordinary skill in the art will appreciate that laptop computers now have the processing power to practice the present invention, and eventually even more compact and portable computing devices such as the PDA (Personal Digital Appliance) will have this capability.

Similarly, improvements in networking are expected, so the present invention is not limited to use of the Internet in the form we know it today. The present invention is intended to encompass all such foreseeable advances in equipment and communication methods.

Preferred Computer Hardware/Software Configuration

Software for carrying out the present invention was developed using a personal computer running the WINDOWS 2000 operating system from Microsoft Corp., the EXCEL spreadsheet program from Microsoft Corp. (Office 2000 version), VISUAL BASIC 6.0 (Version 8435), an Office 2000 version and the MATHCAD 8 Professional Edition program from Mathsoft, Inc. The computer had a Pentium 3 central processor with a 128K cache and 128 MB of Random Access Memory (RAM). The software has also been successfully operated on a laptop computer with a Pentium 4 central processor containing a 128K cache and 512 MB of Random Access Memory (RAM) running the WINDOWS XP operating system and Excel 2002 (10.2614.2615), with small changes to commands used in the VISUAL BASIC 6.3 (Version 9108) program. This configuration relies upon MATHCAD 2001i Premium Edition.

Tips on Using the Mathcad and Solver Application Programs

When a user learns and adopts the rules and conventions of application programs for conventional computers, the user adapts to an interface for manipulating and utilizing vast amounts of data to achieve some ordered state of knowledge. What if the user could utilize and manipulate data without learning the rules or conventions of computer programs or even understanding the science, mathematics, technology or logic that underlie the programs? The Answer Machine (AM) concept addresses this simplification. AM solution modules utilize not only specialized programs but also expert knowledge to formulate generalized solutions to complex problems.

Technologically, the AM concept requires a linkage between a simple user interface and highly specialized programs. In these particular formulations, the marketing, portfolio and stock shorting solution modules, through the Visual Basic (VB) programming language, control two highly specialized programs: a statistical analysis program which executes using the MATHCAD program, and a linear programming program which executes using MICROSOFT EXCEL. VISUAL BASIC is a registered trademark of Microsoft Corp. The statistical analysis program represents an adaptation of an inventory control and forecasting method discussed by Robert Goodell Brown in his book Decision Rules for Inventory Management.

The Appendix contains a listing of the statistical analysis program of the present invention. The linear programming program, called SOLVER by Microsoft Corporation, resides within EXCEL. To activate and call these two programs requires two different approaches. Both approaches require diligence and patience for successful implementation. To link the statistical program requires several steps:

First, develop the statistical program in MATHCAD Professional Edition.

Second, remove input data from the MATHCAD statistical program.

Third, open the appropriate spreadsheet.

Fourth, select the appropriate location on the spreadsheet.

Fifth, from the spreadsheet toolbar, select the INSERT command.

Sixth, from the INSERT tableau, select Mathcad OBJECT.

Seventh, for the Mathcad OBJECT select the statistical program, sans input data.

After creating the linkage, operation of the statistical program requires direction by Visual Basic commands to a Professional Edition of MATHCAD; see MATHCAD User's Guide (ISBN: 1-57682-039-4 for MATHCAD 8 or 1-57682-041-6 or 1-57682-221-4 for MATHCAD 2001i) and related documentation for the commands and a description of scripting custom OLE automation objects.

The commands supply data to, and retrieve results from, the statistical program. Input data must have a name: in0, in1, in2, in3 or in4, etc. and output data must have a name: out0, out1, out2, out3 or out4, etc. For example, in0 can be a data vector (one-dimensional matrix) containing 37 or more data points. Furthermore the format on the spreadsheet for the data exchange requires “number”; neither “general”, “accounting” nor “currency” formats operate correctly. Additionally, the input and output data must conform to real and imaginary components of imaginary numbers. If no imaginary component exists, data entry must include the imaginary component with a zero coefficient. Omitting the imaginary result from an output causes no problem.

Assuming that SOLVER has been installed, SOLVER exists within EXCEL. Visual Basic (VB) commands call and execute the SOLVER linear program. However, successful calling and execution of SOLVER requires determination and patience. Similar to the linkage of the MATHCAD statistical program, SOLVER may, or may not, initially respond to the commands. Creating the linear programming layout and constraint equations and manually calling helps with instigating the functionality of the VB commands. However, after activating the VB commands, they may subsequently cease operation. A problem may arise from case sensitivity. For example, after initially causing a solution with “Solversolve”, the command requirement may mutate to “SOLVERSOLVE” or to some other construct with punctuation “Solver.Solve”. Routine experimentation will indicate the most functional commands. Obviously, command structure also depends upon the operating system.

Other hurdles to linkage appear to involve size. It appears easier to link a small MATHCAD program and then enlarge it, rather than install a large program. Similarly, the execution of a small linear program with VB commands succeeds faster than large programs. A step-by-step execution, prior to an uninterrupted program run with loops, also will achieve faster operational results.

Preliminary Data Collection

In order for a business to make plans and decisions, it is usually necessary to first gather data, such as the cost and availability of parts, ingredients, working capital, labor, intellectual property and other inputs, and concerning the demand for, and market value of, the expected products and/or services of the business. In an investment management context, there are similar needs to obtain historical and current data on prices of various securities and investment properties. Typically, such data is communicated from either a commercial outside data supplier's computer or from another computer within the business. Depending upon the sensitivity of the data, it may be transferred in encrypted form.

Generally, when the analysis according to the present invention has been performed, the results of the analysis, or instructions based on that analysis, may be communicated to other persons within the business by computer transmission.

Description of FIG. 1A—User Steps for Answering Machine

This algorithm describes Answer Machine directions, to a user, about how to utilize sophisticated application programs and analysis, without understanding either details of the analysis or learning the application programs. Depending upon the user's familiarity with the Answer Machine and the issue at hand requiring resolution, the user may repeat the algorithm steps up to three times, before initiating the resolution process. A user can exit the algorithm at any time during the algorithm's execution.

As shown in FIG. 1A, a user initiates the algorithm at step 102a by triggering execution of the Answer Machine program module, for example by clicking a button or speaking a verbal command. Next, the user indicates, at step 112a, what issue or problem needs solution. If the user wishes to address a problem solution, the algorithm proceeds to step 114a. If the user desires general information about the Answer Machine concept or its usage, the algorithm proceeds to step 116a.

If the user does not require general information about Answer Machine usage, the user can elect to review an example problem solution at step 120a. After reviewing the example, or if the user elects not to review an example, the algorithm proceeds to step 122a, to offer the user a choice between personal and commercial problems.

If the user selects commercial problems, the algorithm proceeds to step 182a and offers the user a menu of commercial problems that include finance, investing, and marketing problems, among other commercial possibilities. After the user selects a commercial problem category, the algorithm at step 130a hyperlinks to a respective explanation about that type of problem. The explanation includes a broad-review of various aspects of the problem, including some aspects which the user may have overlooked or omitted from consideration. For example, a user might overlook marketing expenses for existing products as a concern in a product development program. Yet, the marketing solution module includes an optimized balance of tradeoffs between each product, its price, marketing/sale budget and economic attractiveness for product replacement and ingredient substitution. Furthermore, the marketing solution module performs the tradeoffs with statistical, optimization and expert analyses beyond traditional methods, and possibly beyond the user's comprehension.

Beside general aspects of the problem, the explanation indicates the specific information and data requirements necessary to achieve a balanced solution to the problem.

According to a preferred embodiment, for the marketing problem, the solution requires: 36 periods of sales data for each product, the marketing/sales budget per unit of product, the ratio of each ingredient used per unit of product output, separated by inventoried and non-inventoried ingredient, the inventory of products and ingredients, and the prices of products and ingredients. The user has the choice of how to enter the required information into the solution module, either manually or by loading one or more pre-existing data spreadsheets. If, upon initial review, the user lacks the information specified by the program, the user can elect, at step 132a, to exit the algorithm at step 134a, in order to first collect the required information. A user in a large business probably has access to databases that contain the required data. A user in a small business may have to cull the required information from accounting records.

If the user selects a personal problem at step 122a, the algorithm proceeds to step 124a and offers the user a menu of personal problems that include: finance, investing, health and other personal issues. After the user selects a problem area, the algorithm at step 126a hyperlinks to a respective explanation about that kind of problem. The explanation includes a broad review of various aspects of the problem, including some aspects which the user may choose to omit from consideration. Beside general aspects of the problem, the explanation indicates the specific information and data requirements necessary to achieve a balanced solution to the problem. If, upon initial review, the user lacks the information specified by the program, the user can elect, at step 132a, to exit the algorithm at step 134a, in order to first accumulate the required information, before continuing to use the program.

After collecting the required information, the user re-initiates the algorithm at step 102a and follows the steps returning to step 132a. Having the appropriate data available, the user proceeds with the solution process at step 136a. Depending upon the user's requirements to either format the data or call the solution module, the user uses a hyperlink at step 138a to call either a utility program or the solution module. The user could elect to hyper-link to the solution module and manually enter all data during the solution process. Alternatively, the user could use a hyper-linked utility program to structure the raw data into the correct format for input spreadsheets. Under either condition, the user hyper-links to another algorithm to continue the solution process.

If the user at step 138a hyper-linked to a utility program to structure input data, the user re-initiates the algorithm a third time at step 102a and follows the steps returning to step 132a. The user uses a hyperlink at step 138a to call a solution module of the user's choice.

The remainder of this application discusses in detail several solution modules, namely:
1) Remake, a marketing, sales and marketing/sales budget optimizer with satellite solutions to product development and input substitution components.
2) PD&ISnlzr, a Product Development & Input Substitution Analyzer for optimizing the development of new products for a company (part of Remake);
3) Stknlzr, a stock portfolio management optimizer; and
4) Stkshortr, an optimizer program for managing short sales of securities.

These solution modules access three programs not normally used by average business people. The three programs include statistical analysis templates utilizing MATHCAD (US Trademark Reg. # 1,457,219 of Mathsoft, Inc. of Cambridge, Mass.), an application program for mathematical analysis, and SOLVER, a linear programming module within the well-known EXCEL spreadsheet program (EXCEL is a trademark of Microsoft Corp. of Redmond, Wash.). The third program is an “expert analysis” program. The present invention combines algorithms based on (1) MATHCAD and (2) SOLVER with (3) expert analysis, to thereby provide “solution” modules with enormous flexibility and broad applicability.

Description of FIG. 1B—Mathcad Functions Linked in Solution Modules

This algorithm is an adaptation of an inventory control and forecasting method discussed by Robert Goodell Brown, a consultant at the firm Arthur D. Little Inc., in his book Decision Rules for Inventory Management, pp. 79-211, (ISBN 03-062745-1, published by Holt, Rinehart and Winston, Inc., 1967). The method defines a “Base correlation” and an “Intermediate correlation” which are used in calculating a “Final correlation.” The time periods used in the algorithm may include days or weeks, as well as months. The present invention includes an adaptation of the Brown algorithm, as set forth in the computer program appendix of this application. Note that values used for a smoothing vector (h) in the algorithm of the present invention, are inspired by a mathematical derivation included in the Brown book on pages 144 through 149. However, the Brown book contains mathematical inconsistencies.

The appendix portion of the present application includes a reproduction of the mathematical derivation with corrected equations. The values of the smoothing vector (h) used in the algorithm include: h1=0.035, h2=0.0003278, h3=0.002153, h4=0.035, h5=0.002913 and h6=0.035. The preferred value for h0 in the algorithm equals 0.991, according to the present invention, rather than the mathematically determined 0.982. This difference increases the algorithm's reliance on an error-corrected Intermediate correlation and decreases the emphasis on the Base correlation in the final correlation employing exponential smoothing. The value of ho plays a direct role in the weighting of the different correlations in the exponentially smoothed correlation.

These small value adjustments cause a major impact on the role of the non-error-corrected correlation, because the non-error-corrected correlation's coefficient equals the difference between one and (h0), that is: (1—ho). Thus the difference of (1−0.982=0.0018) as taught by the Brown book is twice the value of the difference according to the present invention (1−0.991=0.009). Using a value of (h0) of 0.991 reduces the impact of the non-error-adjusted correlation to half the weight which it would have, based upon the (h0) value of 0.982 as taught by the Brown book.

The improved inventory control method of the present invention uses function parameters and data which are stored as a worksheet generated using MATHCAD, a computer program for mathematical analysis protected by U.S. Pat. Nos. 5,469,538 and 5,526,475, RAZDOW, and by copyright. MathSoft, Inc., 101 Main Street, Cambridge, Mass. 02142-1521, licenses authorized users of the MATHCAD program to practice the method(s) recited in those U.S. patents.

Referring to FIG. 1B, the algorithm commences at step 102b with a call to a statistical analysis worksheet created in MATHCAD. This call initiates a double-click on the MATHCAD worksheet (treated by VISUAL BASIC code as an object) to establish a link to the MATHCAD program. After alerting the MATHCAD worksheet, the algorithm at step 112b transfers a data vector of 36 elements from a template to the MATHCAD worksheet for processing. These 36 elements consist of sales data from the “Remake” template or securities prices from the “Stkanlzr” or “Stkshortr” templates. For programming reasons, the actual vector contains 37 elements, with the first element equaling zero. This extra element permits a “startup” phase of the statistical analysis process, without compromising any of the 36 data elements. At step 114b, the MATHCAD worksheet performs a series of mathematical steps to determine the coefficients used in the Base correlation analysis, which a statistician might also call a “regression” analysis. These coefficients change for every data element (sales or stock prices) and every time the user runs the solution module with different data. The worksheet then performs a correlation analysis consisting of four terms: the level of the data, the trend of change in data and two terms of data oscillation. Each of the data oscillation terms consists of sine and cosine expressions. The first oscillation term relies on a 30-degree phase. The second variability term relies on double the frequency of the first variability term with a 15-degree phase. After determining the Base correlation, the worksheet measures the difference between the correlation and the actual input data.

At step 116b, the MATHCAD worksheet determines an “Intermediate correlation” consisting of four terms: the level of the data, the trend of change in data and two terms of data oscillation. Each of the data oscillation terms consists of sine and cosine expressions. The first oscillation term relies on a 30-degree phase. The second variability term relies on double the frequency of the first variability term, with a 15-degree phase. Essentially, the Intermediate correlation consists of the Base correlation plus error propagation terms. Mathematically, the Intermediate Correlation consists of the Base correlation value, one period earlier, plus a coefficient times the absolute value of the difference between the actual data and the Base correlation estimate one period earlier. The coefficients for the difference (or error) terms equal: h1=0.035, h2=0.0003278, h3=0.002153, h4=0.035, h5=0.002913 and h6=0.035. These coefficients result from a unit matrix solution for a correlation reflecting a cycle with 18 periods with a 30-degree phase and assuming the input data cover two cycles. See the Appendix for the derivation of these coefficients. Also note the derivation reflects the presentation of Robert G. Brown in Decision Rules for Inventory Management, Holt, Rinehart and Winston, Inc.; 1967, pp. 145 to 149, with appropriate mathematical corrections. After completion of the Intermediate correlation, the worksheet performs a second error analysis by measuring the difference between the actual data elements and the Intermediate correlation's estimated values. Finally, the worksheet determines a number of statistical measures concerning the significance of the various coefficients in the accuracy of the correlation analysis.

At step 118b, the worksheet determines the final correlation and forecasting tool. The final correlation derives from exponential smoothing, the technique of using a fraction as a coefficient for one term and one minus the fraction as a coefficient for a second term. Mathematically, the final correlation consists of (0.991) times the Intermediate correlation value for the prior period less (1−0.991=0.009) times the Base correlation for the prior period, added to the trend coefficient times the period number for the prior period. The value for ho in the algorithm equals 0.991 rather than the mathematically determined 0.982. This difference reflects an attempt to permit the algorithm in the final correlation to place greater emphasis on the Intermediate correlation and less emphasis on the Base correlation. The worksheet proceeds to step 120b and plots the various correlations and data series, to provide visual confirmation of the relevance and usefulness of the correlations. Step 120b also performs some extraneous calculations. Although a user may choose not to display these graphs, nor desire the extra calculations, they remain in the linked program to delay the MATHCAD worksheet completion.

Under certain conditions, a linked MATHCAD worksheet may not be allocated sufficient execution time to complete its calculations, and communicate results to the host spreadsheet. The inclusion of extraneous time-consuming calculations appears to offer a practical work-around to this problem. After the momentary delay, the worksheet at step 122b conducts the final calculations in preparation for communicating with the host worksheet. These calculations include the following:

1) determining the user's upper variability for a unit normal distribution about mean of zero;

2) determining the specific data series' upper variability by: multiplying the unit normal distribution's upper variability by the mean average deviation of the Intermediate Correlation and multiplying by (1.25). The standard deviation equals (1.25) multiplied by the Mean Average Deviation.

3) determining the user's lower variability for a unit normal distribution about mean of zero;

4) determining the specific data series' lower variability by multiplying the unit normal distribution's lower variability by the mean average deviation of the Intermediate correlation and multiplying by (1.25).

5) determining the coefficient for the trend component of the Base correlation;

6) determining the variability for the trend component of the Base correlation and

7) determining a forecast for the data series from the final correlation.

The final calculation involves subtracting the initial data series value from the 37 terms of the final correlation's forecast and dividing by 36.

The worksheet's step 124b then transmits the forecasts for the next 36 periods after the current period, upper variability, lower variability, trend coefficient, trend coefficient variability and forecast to the host spreadsheet. The host spreadsheet receives the 8 results and stores them in the appropriate locations on sheet 1. Rows 2 through 37 of Column AJ receive the forecasts for the next thirty-six periods. Column AI's: Row 41 receives the upper variability, Row 43 receives the lower variability, Row 45 receives the trend coefficient (growth rate), Row 47 receives the trend variability and Row 49 receives the averaged forecast.

The spreadsheet algorithm moves the values from Column AJ to the appropriate column for the data series with:

1) Rows 39 through 41 capturing the forecasts for first three periods.

2) Row 43 capturing the high variability.

3) Row 44 capturing the low variability.

4) Row 45 capturing the Trend Coefficient (growth rate).

5) Row 48 capturing the Trend Coefficient uncertainty.

6) Row 49 capturing the averaged forecast.

After transmitting the statistical analysis output, the MATHCAD worksheet at step 126b ceases and returns to the host spreadsheet. The host spreadsheet may return to the MATHCAD spreadsheet for statistical analysis of another data set or the algorithm may continue to another step on the solution path.

Description of FIG. 1C—Algorithm Linked in Remake, Stkanlzr & Stkshortr Template Solution Modules

This algorithm derives from a linear regression method. The time periods used in the algorithm may include days, weeks or months. This linear regression methodology resides in a program stored as a worksheet in MATHCAD, an application program for mathematical analysis. MathSoft, Inc., the program's publisher, authorizes purchasers of MATHCAD to practice the method steps claimed in the RAZDOW patents, cited above.

Referring to FIG. 1C, the algorithm commences at step 102c with a call to the second statistical analysis worksheet in MATHCAD. Depending upon the solution module, a self-inspection may occur that indicates an abstention from making the call. The self-inspection evaluates input data to determine if a monotonic increase or decrease exists. If it exists, then the possibility of a linear growth exists. Absence of monotonic increasing or decreasing data indicates a lack of linear growth and irrelevance of the linear regression analysis. Stock price data generally exhibit all types of change except linear behavior. Nevertheless, the solution modules, “Stkanlzr” or “Stkshortr” always perform the linear regression analysis. This forced evaluation occurs to avoid the reversal of the linkage process. Repeated use of the “Stkanlzr” or “Stkshortr” templates without calls to the linear regression analysis could eventually break the linked connection with the linear regression analysis. Breaking the connection would make the linear regression analysis unavailable on some future occasion when it requires investigation.

After alerting the MATHCAD worksheet, the algorithm at step 112c transfers a data vector of 36 elements to the MATHCAD worksheet for processing. These 36 elements consist of sales data from the “Remake” template or stock prices from the “Stkanlzr” or “Stkshortr” templates. For programming reasons, the actual vector contains 37 elements with the first element equaling zero. This extra element permits a “startup” phase of the statistical analysis process without compromising any of the 36 data elements.

At step 114c, the MATHCAD worksheet, linked in Sheet5 of “Remake”, “Stkanlzr” or “Stkshortr”, performs a simple linear regression analysis between the input data and the period numbers (from 1 to 36). These coefficients change for every data element (sales or stock prices) and every time the user runs the solution module with different data.

At step 116c, the MATHCAD worksheet determines the slope and intercept for the regression elements. At step 118c, the worksheet performs a correlation between the regression and the input data. The worksheet then forecasts the values for the next three periods, based on the regression. The worksheet proceeds to step 120c and plots the regression and the data series to provide visual confirmation of the relevance and usefulness of the regression. Step 120c also performs some extraneous calculations concerning differences between the data and the regression values. Although a user may choose not to display these graphs nor desire the extra calculations, they remain in the linked program to delay the MATHCAD worksheet completion. Under certain conditions, a linked MATHCAD worksheet may not receive sufficient time to complete its calculations and communicate results to the host spreadsheet. The inclusion of extraneous calculations appears to offer a practical work-around to this problem.

The worksheet's step 124c then transmits the: the slope of the regression, the intercept of the regression, the correlation coefficient of the regression with the input data and the forecasts for the next three periods after the current period. The host spreadsheet receives the 6 results and stores them in these Row locations of Column AP on sheet5: Row 39 receives the regression slope, Row 41 receives the regression intercept, Row 43 receives the correlation coefficient, Row 45 receives the forecast for the next period, Row 47 receives the forecast for the second period and Row 49 receives the third period forecast. The spreadsheet algorithm moves the values from Column AJ on Sheet5 to Sheet1's appropriate column for the data series with:
Row 59 holding the first period forecast.
Row 60 holding the second period forecast.
Row 61 holding the third period forecast.
Row 62 holding the slope.
Row 63 holding the intercept.
Row 64 holding the correlation coefficient.

After transmitting the statistical analysis output, the MATHCAD worksheet ceases at step 126c and returns to the host spreadsheet, either to analyze another data set or continue to another step in the solution process.

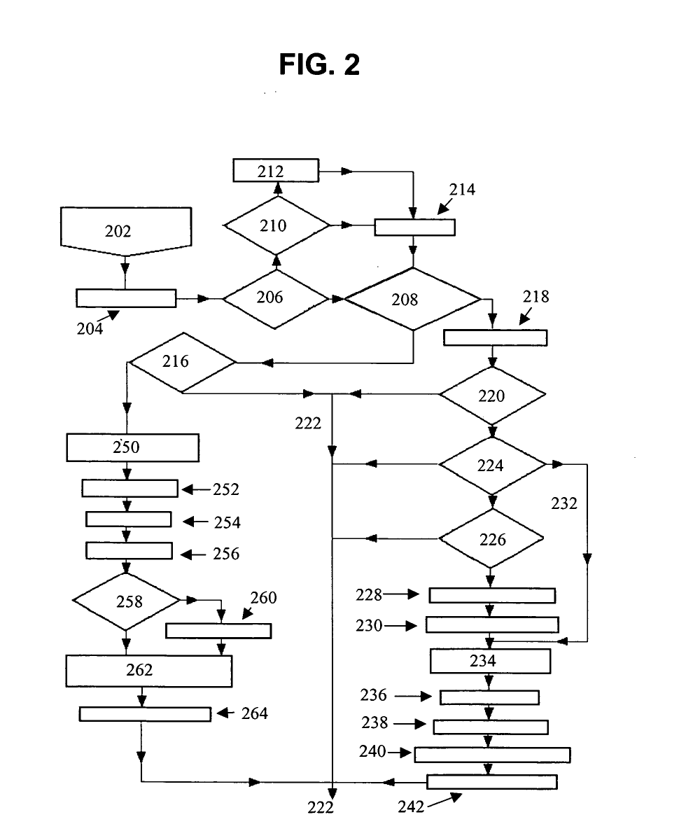

Detailed Description of FIG. 2

FIG. 2 illustrates the steps in a data gathering method used in the solution of business, stock portfolio management or stock shorting problems. A first step 202 when running the program is to call a utility program called LPutilities, a workbook with data structuring subprograms. The second step 204 is to open a subprogram on LPutilities Sheet2 called Mnulxlprodmdspsht. The third step 206 is to perform a check to determine whether there has been a rollover from prior execution from Sheet1 of a Ratio Builder subprogram, RatioBldr; if yes, execution branches to a step 208, described below; if no, execution branches to a step 210 of checking whether or not the user wants to use a text-to-voice option; if yes, a text-to-voice subprogram is activated in a step 212; if no, execution goes directly to a step 214 of prompting the user to enter a user name. If text-to-voice was activated in step 212, execution also goes to step 214 of getting the user name.

After the user name has been obtained, the user is prompted, in a step 208, to tell the program whether or not data are going to be entered manually by the user; if yes, execution branches to a step 216 of checking a PMS (Product Market Segment or stock) count, to be described below; if no, execution branches to a step 218 of prompting the user to enter the name of a spreadsheet file which contains data needed by the program, stored in a matrix having as many dimensions as needed for solution of the problem being solved. This is the user-friendliest and preferred way to run the program since, by avoiding manual entry of data, the user saves considerable time and possible key stroking or misinterpretation errors.

Automated Data Entry Alternative

After data have been loaded from a spreadsheet file specified by the user, a step 220 check whether the term “Date” exists in column one, row one, to indicate date information is present. This is important since the program solution process needs date information in the proper location to execute.

If the result of step 220 is no, meaning date information is not present, execution follows a path 222 to exit the program.

If the result of step 220 is yes, meaning date information is present, a step 224 checks whether a Product Market Segment (PMS) (or stock) count is correct (within a predetermined acceptable range), is too large, or is too small. If the count is too large, for example the user is trying to evaluate a product mix containing more products, and thus more computations, than the user's computer can handle, execution branches to exit path 222, previously mentioned.

If the count is too small, the user is prompted to increase the PMS (or stock) count, e.g. by adding another product (or stock) to the mix. A step 226 checks whether the revised count has reached a predetermined minimum number; if no, execution branches to exit path 222; if yes, the user is prompted to enter additional PMS product (or stock) names at step 228 and a respective demand (or stock price) number for each at step 230. Step 230 queries the user for demand (or stock price) data according the date information provided by the spreadsheet data file of insufficient PMS (or stock) count. As the user responds to the query, step 230 records the input at the appropriate location on LPutilities Sheet2.

Back in step 224, if the PMS count was acceptable, execution jumps along a path 232 which avoids steps 226, 228 and 230 and goes directly to a step 234 which moves the data gathered to LPutilities Sheet2.

Next, a step 236 queries the user for the number of periods of obsolete data and removes that number of periods of data from the beginning periods recorded on LPutilities Sheet2. Step 236 then reconfigures the remaining data such that the earliest period occupies the initial spreadsheet position. Step 238 queries the user for recent demand (or stock/security price) data and places that data at positions of the latest periods on Sheet2. Step 240 moves the updated data from LPutilities Sheet2 to the original spreadsheet.

A step 242 removes all data from the LPutilities Sheet2 for re-use for data updates. Finally, execution follows exit path 222.

Manual Data Entry Alternative

As previously mentioned, if the user in step 208 indicated a preference to enter data manually, execution branches to a step 216 which checks whether the PMS count is OK; if no, execution branches to exit path 222; if yes, execution follows a path shown in the lower left quadrant of FIG. 2. First, a step 250, for PMS's, prompts the user through a Form to select either daily, weekly or monthly periods. For stocks, the user can only elect weekly periods. For PMS's, a user might require a sequence of periods, which typically are at intervals of one or more days, weeks, or months, for example 36 monthly intervals spanning a period of three years, a typical life cycle for a mixture of products in an industry with a reasonable but not excessive amount of technological change. Of course, this is only an example, and similar calculations can be performed for shorter or longer time periods, depending upon the nature of the user's real-world problem. In step 252, as the user enters 36 period dates, step 252 checks if the dates correspond to the daily, weekly or monthly periods selected during step 250. As the user provides dates, step 252 checks for inappropriate periods and, if it determines incorrectness, alerts the user and provides an opportunity to correct the dates. In step 254, the user is prompted to enter PMS (or stock) names. In step 256, the user is prompted to enter PMS demand (or stock price) numbers according to the dates provided in step 252. If the user enters PMS data, a step 258 checks whether the user wishes to use the Ratio Builder subprogram, RatioBldr.

As marketing/sales problem solutions require ratios of PMS output to input ingredients, the user must eventually determine these ratios. Having developed a spreadsheet with PMS listings provides an ideal time to create the ratio spreadsheet. If the user answers YES to step 258, a step 260 activates RatioBldr on Sheet1 of LPutilities; if the user answers NO, or after step 260 has been executed, a step 262 saves data to a spreadsheet, with the fallback name “ProDmdmQuery.” Then, a step 264 cleans the LPutilities Sheet2 of all data, to prepare it for use with fresh data later. Execution then follows exit path 222.

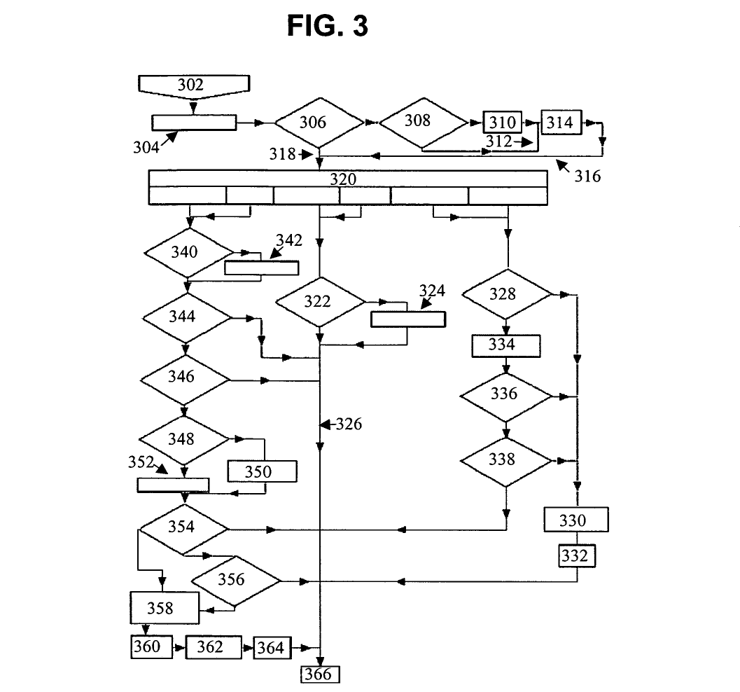

Description of FIG. 3

FIG. 3 illustrates how to formulate ratios for use in linear programming calculations for products produced from multiple but shared ingredients. In a first step 302, the LPutilities program is called. In a second step 304, the Ratio Builder subprogram, “RatioBldr” on sheet1 of LPutilites is called. Then, in step 306, a check is made whether a PMS builder rollover occurred from LPutilities subprogram “Mnulxlprodmdspsht” on sheet2. If the answer is NO, the program goes to a step 308 which asks whether the user desires voice instruction; if the answer is YES, the program activates voice instruction in step 310; otherwise, the program skips step 310 and goes along path 312 directly to a step 314 which gets the user's name. Thereafter, the program follows a path 316 which joins a YES path 318 from the result of step 306, both leading to a step 320 which determines the data content of any spreadsheets which are open.

The possible answers to the test in step 320 are: none open, inventory only, PMS only, inventory & PMS, business optimizer and ratio spreadsheet. If none are open or only inventory spreadsheets are open, execution jumps to a step 322 which tests whether to go to LPutilities subprogram “Mnulxlprodmdspsht” PMS Builder; if YES, LPutilities subprogram “Mnulxlprodmdspsht” PMS Builder is opened in step 324; if NO, execution proceeds along a path 326 leading to program termination at step 366 or instigating the user to use the PMS Builder “Mnulxlprodmdspsht” described in FIG. 2.

If step 320 finds that a business optimizer spreadsheet or a ratio spreadsheet is open, a step 328 tests whether the spreadsheet name is “PMSINPTRatio.” If the answer is YES, execution jumps to a step 330 which makes a row and column count by performing character recognition along the first row and first column. When step 330 encounters an empty cell along the first row, it determines the count of products or PMS's. When step 330 encounters an empty cell along the first column, it determines the count of inventoried ingredients. Step 332 follows step 330 and reviews the ratios in the open spreadsheet with the user. If the user needs to adjust a ratio, the user performs the adjustment during the step 332 query process.

If the result of step 328 is NO, the user is prompted, in a step 334, to enter the name of the spreadsheet. The program, in a step 336, inspects the identified spreadsheet and asks the user whether or not the spreadsheet is a “ratio only” spreadsheet. If the answer is YES, execution continues at step 330, previously discussed. If the answer is NO, then the user wants to update an existing LP solution spreadsheet for a Business Optimization, so a decision is made by the program, in a step 338, to warn the user that updating an existing LP solution spreadsheet may involve the eventual use of outdated sales information in the revised Business Optimization and then asks the user, whether or not he/she still wishes to update the LP solution spreadsheet ratios. If the answer is YES, execution continues at step 330 as previously discussed. Execution continues at step 332 as previously discussed to query the user about the ratios. If the answer is NO at step 338, LPutilities clears itself of all data and then follows path 326, previously discussed, to exit the program.

Returning to step 320, if the open spreadsheets are determined to be either “PMS only” or “Inventory & PMS,” a test 340 determines whether or not the spreadsheet name is “ProDmdmQuery.” If the answer is NO, the user is prompted, in a step 342, to enter the spreadsheet name. If the answer is YES, or if the user has entered a new spreadsheet name, execution continues with a test 344 which determines whether or not date information is present. If the answer is NO, execution follows path 326, previously discussed. If the answer is YES, a step 346 tests whether or not the PMS count is OK. If the count falls below 5 PMS's or products, a linear programming analysis makes no sense because of an insufficient count. If the count exceeds 25, the current LP solution technique approaches overload. A different LP solution technique could raise the 25 limit substantially. For example, the MATHCAD optimizer permits a count up to 500. Other LP optimizers go up to 10,000. However, this introduces another problem; business people excessively studying individual products rather than product marketing segments.

If a business has more than 25 products, those products need weighted average reductions into PMS's or product market segments. The standard industrial code (SIC) encompasses 32 segments to cover the entire US economy. As no single company serves all sectors of the US economy, a limit of 25 PMS's should permit appropriate aggregation to allow any company to analyze its PMS's. If the answer is NO, execution follows path 326.

If the answer is YES, a step 348 asks the user whether an ingredient spreadsheet is open. The user needs an ingredient spreadsheet with inventories of ingredients, in order to conduct the LP marketing/sales solution process. If the user does not have an ingredient spreadsheet, then they need to create it. If the answer is NO, a step 350 assists the user in the creation of an ingredient inventory spreadsheet by asking for, and recording, the names of ingredients and then asking for and recording the inventory for those ingredients. Step 350 by default names the inventory spreadsheet “IngInv Query.” If the answer is YES, the user is prompted, in a step 352, to enter the spreadsheet name.

Next, a step 354 tests whether the count of ingredients is too high, too low, or acceptable. If there are too many ingredients (count exceeds 25; likely LP solution technique overload), execution follows path 326 to quit. If there are too few ingredients, a step 356 asks the user to enter sufficient additional non-inventoried ingredients during the solution process to meet a minimum of 5 total ingredients.

If the user fails to add sufficient non-inventoried ingredients and there are still too few, execution follows path 326. If the user indicates the addition of sufficient ingredients has added enough non-inventoried ingredients in step 356 for the total ingredient count to fall within a predetermined acceptable range (e.g. 5-20) or if step 354 had already determined that the count was an acceptable number of ingredients, a step 358 creates a spreadsheet called “PMSINPTRatio.” This is the spreadsheet which step 328, previously discussed, seeks. Once the spreadsheet has been created, a step 360 gets the PMS names from either “PrDmd Query” as specified in step 340 or the user selected name as specified in step 342.

Then, a step 362 uses the spreadsheet “IngInv Query” to prompt the user to enter the names of ingredients per unit of PMS. Finally, a step 364 queries the user about ratios as it does at step 332. Upon completion of step 364, LPutilities clears itself of all data and saves the changes to “PMSINPTRatio” and then proceeds to 366 for termination and closure.

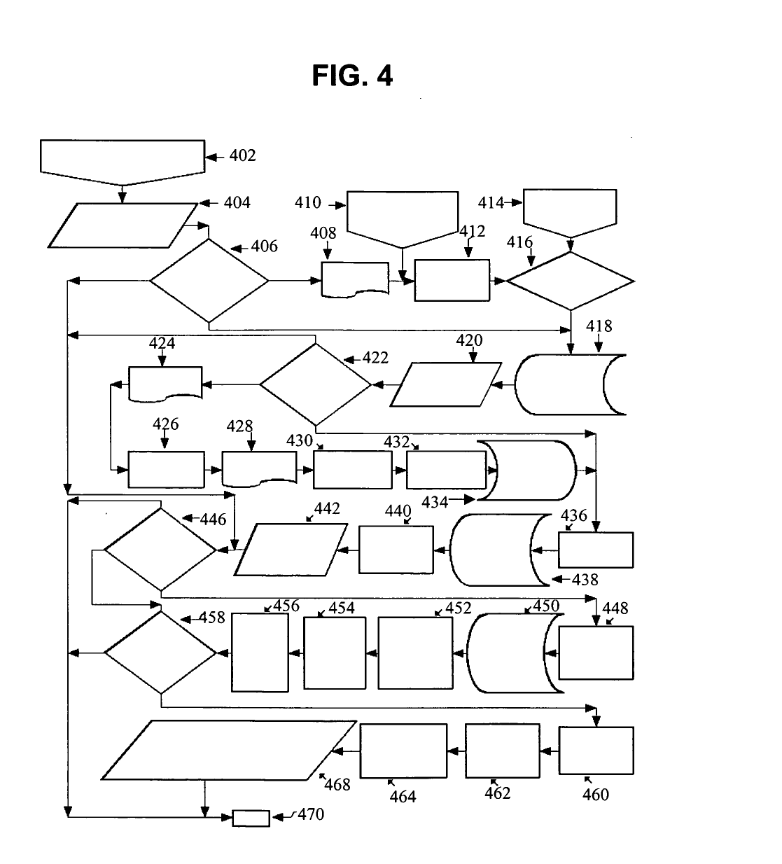

Description of FIGS. 4-6:

Answer Machine Solution Blocks

Solution Block 1 (FIG. 4: Steps 402 to 422;

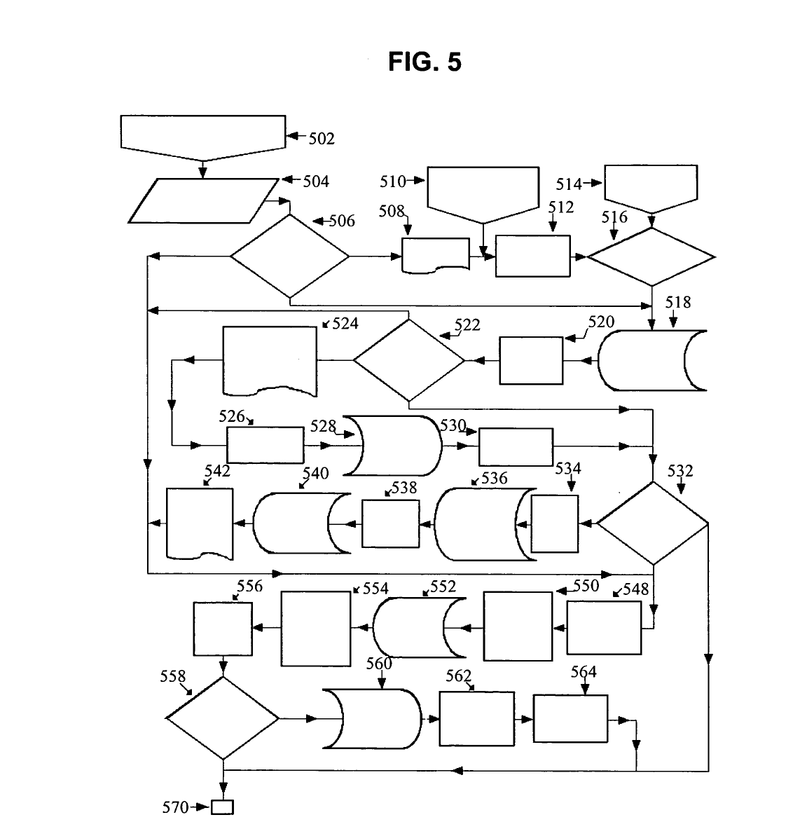

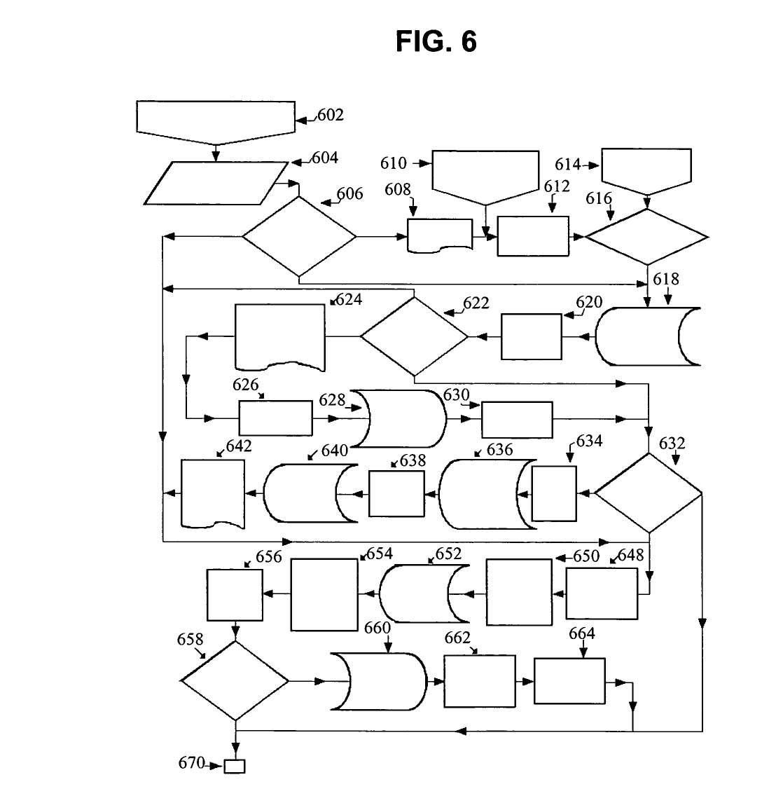

FIG. 5: Steps 502 to 522 and FIG. 6, Steps 602 to 622)

Block 1 contains algorithms to address 5 issues:

1) An algorithm that reads the state of completion of the module at the initiation of the processing Block and marks the completion of the Block;

2) Algorithms request the user to enter data and identify the method of data entry, manually or automated from user generated or database generated spreadsheet and check data for conformance to required input format;

3) An algorithm querying the user whether the input data requires adjustment and if so, permitting the user to adjust the input data and

4) An algorithm to statistically analyze the data.

5) An algorithm to complete data input: in the marketing solution module, adding input data for non-inventoried ingredients; in the portfolio management and stock shorting modules, sorting stocks by price variability (risk).

Algorithm to Determine the Module's State of Completion

MARKETING SOLUTION MODULE: See FIG. 4 flowchart. The marketing module spreadsheet, “Remake,” checks the status of spreadsheet completion at Steps 406, 422, 446, 458 and 468. As Step 406 begins the first processing Block, the algorithm looks for no entry at spreadsheet, “Remake Sheet2,” position, Row 3 Column E, “E3” to begin processing at Step 408. The conclusion of the processing Block at Step 420 includes an entry of “1” at position “E3” of spreadsheet, “Remake Sheet2.”

PORTFOLIO MANAGEMENT MODULE: See FIG. 5. flow sheet. The portfolio management module spreadsheet, “Stkanlzr”, checks the status of spreadsheet completion on Sheet2 at Steps 506, 522, 532 and 558. As Step 506 begins the first processing Block, the algorithm looks for no entry at spreadsheet, “Stkanlzr Sheet2,” Row 3 Column E, “E3” to begin processing at Step 508. If Step 506 finds a value of “2” at position “E3” it begins processing to Step 532. If Step 506 finds a value of “3,” it begins processing at Step 548. The conclusion of the processing Block at Step 522 includes an entry of “1” at position “E3” of Sheet2 of “Stkanlzr.”

STOCK SHORTING MODULE. See FIG. 6 flowchart. The portfolio management module spreadsheet, “Stkshortr”, checks the status of spreadsheet completion on Sheet2 at Steps 606, 622, 632 and 658. As Step 606 begins the first processing Block, the algorithm looks for no entry at spreadsheet, “Stkshortr Sheet2,” Row 3 Column E, “E3” to begin processing at Step 608. If Step 606 finds a value of “2” at position “E3” it begins processing to Step 632. If Step 606 finds a value of “3” it begins processing at Step 648. The conclusion of the processing Block at Step 622 includes an entry of “1” at position “E3” of Sheet2 of “Stkshortr.”

Data Input Entry and Algorithms to Check Data Comformity & Count the Inputs

A user opens a solution module by hyperlinking from the Answer Machine interface for the user's problem. The user makes this hyperlink as previously discussed (FIG. 2) after determining the required data for a problem solution. In the case of marketing/sales problems, the user would hyperlink to the solution module, “Remake”. For portfolio management, a user would hyperlink to the solution module, “Stkanlzr”. For stock shorting, a user would hyperlink to the solution module, “Stkshortr”. These hyperlinks represent: FIG. 4, step 402, FIG. 5, step 502 and FIG. 6, step 602. Assuming data availability, the user begins the solution process by pressing a button titled, “Push for Mktg, Sales, Price Analysis” on Remake Sheet2, or titled, “Push for Portfolio Review” on Sheet2 of either “Stkanlzr” or “Stkshortr”. After welcoming the user and obtaining the user's name, the modules either acquire the requisite data from appropriate spreadsheets or from manual entries by the user.

The algorithm (FIG. 4, Step 408, FIG. 5, Step 508 and FIG. 6, Step 608) checks the input data for conformity with a preferred data format (Steps 412, 512 or 612). The required input structure consists of: the word “Date” in the first row of the first column and names of products or product market segments in the first row starting after the word, “Date.” The marketing solution module permits date entries of days, weeks or months. The portfolio management module and the stock shorting module are preferably configured to only accept weekly “dates.” Monthly stock data cover too lengthy a time period and daily stock data cover too brief a time period for useful analysis.

The algorithm performs the same inspection (FIG. 5, Step 508 and FIG. 6, Step 608) for stock symbols for the portfolio management and stock shorting modules, in addition to seeking three specific symbols: QQQ, SPY and DJA (“index” securities representing, in the US, stocks listed on the NASDAQ system, the Standard & Poor's and the Dow-Jones Industrial Average, respectively). To allow the generalization of the solution module, the actual count of products, product market segments or stock symbols remains a variable throughout the solution modules. The algorithm counts the number of products or stock symbols at the reading of the data input and at appropriate times (FIG. 4, Steps 422, 446, 458 and 468 of the Marketing Module; FIG. 5, Steps 522, 532 and 558 of the Portfolio Management Module, and FIG. 6, Steps 622, 632 and 658 of the Stock Shorting Module) throughout the solution module. After making the count, the algorithm checks the count against a minimum and maximum number specified in the algorithm. If the count meets the count criteria, it becomes an essential input to the solution module affecting the spreadsheet layout and the linear program equations used to solve the problem. If the count meets the count criterion, the algorithm stores the input data on Sheet1 of the solution spreadsheet, “Remake” for the marketing module and “Stkanlzr” for the portfolio management module and “Stkshortr” for the stock shorting module. For the marketing, portfolio management and stock shorting modules the algorithm requires a minimum of five (5) products, product market segment or stocks. The use of linear programming in the solution process sets the minimum. It makes no sense to conduct an LP analysis with fewer than five (5) components. The current LP solution technique creates an upper bound of twenty-five (25) on the count of stocks, products or product market segments. The use of a more capable LP solution technique could raise the maximum considerably. Some LP solution techniques can handle a count up to ten thousand (10 000) although a count of one thousand (1000) represents a more common limit.

However, use of a count in the hundreds misses the point of the solution module. A large complex manufacturer such as an automobile manufacturer should not enter automobile models as products and the thousands of components as the ingredients. In fact an auto manufacturer should not enter products but young, middle aged and retired males and females of various income brackets as the product market segments (PMS's). Auto, SUV (Sport Utility Vehicle) and truck models represent the ingredients to serve these PMS's. After determining what PMS's to serve and what models best serve them, a second tier analysis would focus on general model classifications and the groups of components: bodies, engines, transmissions, electrical components and accessories as the ingredients to these product classes. An intelligible marketing solution evolves over several iterations as the user focuses on the best PMS's, the appropriate product classes to serve the PMS's, the appropriate component groups to meet those product classes and ultimately the appropriate types of components to meet the product classes.

Appropriateness relates to the consideration of “opportunity cost”, an economic concept concerning the cost of performing one action versus another. Contributors (products or market segments which contribute to profitability) have no “opportunity cost” associated with them. Non-contributors (products or segments which have a less-than-optimal profitability) do have an “opportunity cost”. An optimized course of actions minimizes “opportunity cost” by focusing efforts on contributors and minimizing efforts on non-contributors.

An optimized business solution consists of: contributor PMS's, contributor product classes, contributor component classes, contributor ingredients, a roster of non-contributors, an optimized sales and marketing budget and a methodology to decide what to do about non-contributors. Trying to short-circuit this process by entering thousands of ingredients, including every nut, bolt and screw, will not prove enlightening in focusing the business for optimal profitability.

Algorithm Querying the User Re the Need to Adjust Input Data

After acquiring the input data, FIG. 4, Step 410, FIG. 5, Step 510, & FIG. 6, Step 610, load a statistical analysis, previously discussed, MATHCAD program into the spreadsheet memory. FIG. 4, Step 412, FIG. 5, Step 512, & FIG. 6, Step 612, query the user about the need to adjust the input data for changed conditions. Consider the expected addition of a new sales account. The user can expect the new account to generate a certain level of sales in the future. Therefore, the user should add the anticipated sales to the historical data to reflect the new incremental sales expected for the new account. Without an adjustment to historical data, the sales forecast will not include the new sales account in the forecast. Conversely, the loss of a customer would require the user to decrease historic sales to account for sales that had existed for that customer that would no longer occur in the future. A similar algorithm (FIG. 5, Step 512 and FIG. 6, Step 612), in the portfolio management module, allows a user to adjust historic stock prices to account for more up-to-date stock market realities.

Algorithm to Statistically Analyze Input Data

After checking data consistency, FIG. 4, Step 414, FIG. 5, Step 514, & FIG. 6, Step 614, call the statistical analysis program previously mentioned. The algorithm, FIG. 4, Step 416, FIG. 5, Step 516, & FIG. 6, Step 616, request the user to set variability levels associated with probability distributions for the inputted data. The algorithm suggests an upper bound of 0.95 from a possible range of 0.95 to 0.99 and 0.68 for a lower bound of a possible range of 0.5 to 0.68.

Concerning the statistical analysis of input data, the analysis consists of an algorithm (FIG. 4, Step 418, FIG. 5, Step 518 and FIG. 6, Step 618) that uses two separate methods to analyze the input data on Sheet1. The first method, previously discussed, involves a complex combination of linear and Fourier analysis and correlations. Next, the algorithm subjects the correlation results to an error analysis, relative to actual input data. That comparison leads to the development of a normal distribution of uncertainty of the correlation relative to the actual data. Thus a user of the correlation could express a required confidence level, say 95 percent, and determine a correlation result of an estimated median value, + or − some error value, such that the user can feel comfortable that, 95 times out of 100, the actual value will fall within the correlation median value + or − the error value.

The resulting error-corrected correlation then forecasts 36 periods into the future, for either stock prices or product sales. The uncertainty value, associated with the forecast, accounts for the variability of the forecast. Naturally, the forecast rests on the assumption that the future will reflect past performance. For the marketing module, the selection of variability range reflects practical considerations of customer service levels and required product production and inventories to support those customer service levels.

In the portfolio management module, the variability ranges reflect the anomaly of stock price fluctuations. Proprietary research indicates that the distribution of stock prices about a median value reflects a skewed distribution closer to a Poisson distribution rather than a Normal distribution. The sharp decline in prices above the median versus the slowly declining distribution of prices below the median reflects the long held suspicion that investors sell profitable investments too soon and hold unprofitable investments too long. For both modules, the algorithm suggests 95 percent for the large variability band and 68 percent for the small variability band. These bands will comprise the stock price variability estimate for each stock.

The second statistical analysis, previously discussed, involves a simple linear correlation of historic data. If the correlation coefficient exceeds 0.95, the algorithm selects the simple linear correlation for the forecast of product sales or stock price forecasts. The algorithm stores the statistical results including: correlation results, small and large uncertainty bands, forecasts for the next three periods, the average forecast for the next 36 periods and forecasted growth rates on Sheet1.

One aspect of the statistical analysis algorithm that deserves note involves instructions about what not to do. The algorithm for the marketing module involves instructions to test whether the average of the first three, middle three or last three periods of sales history represent a monotonic (consistently directed) increasing or decreasing series. If they exhibit a concave or convex shape, the entire series reflects non-linearity. If the algorithm determines non-linearity, it does not perform the linear correlation analysis. Since the linear analysis requires approximately 50 percent as much processing time as the more complex analysis, skipping the linear analysis can save considerable processing time. In the entirely possible situation that no product sales exhibit monotonic increases or decreases, the elimination of the linear analysis would reduce processing time by 33 percent. Since this algorithm requires approximately 33 percent of the total module processing time, this improvement reduces overall processing time by 11 percent.

Although stock prices generally exhibit non-linear behavior, the portfolio management module (Stkanlzr) contains the linear analysis algorithm. The existence of the linear analysis permits future expansion of the module to serve professional investors. A professional should have the wherewithal to examine a price history for a stock and make realistic and necessary adjustments in prices, possibly leading to a linear progression. Under these circumstances, the linear analysis becomes appropriate.

Algorithms to Complete the Data Input

Marketing Solution Module

An algorithm (FIG. 4: Step 412) requests the names of additional ingredients and the amounts available for each. Then, in step 420, it moves the statistical analysis results into the appropriate locations in the linear program.

Portfolio Analysis Module

An algorithm (FIG. 5, Step 520) performs an extensive sort of stocks according to the price variability risk, relative to the Dow Jones Average (pseudo-stock DJA where DJA=(Dow Jones Industrial Average/1000)×$1), SPY (the index stock for the Standard and Poor's 500) and QQQ (the index stock for the NASDAQ 100). First, the algorithm, using the DJA variability as an index, divides all the other entries by the DJA variability and stores that index result. Next, it determines the average index for all the stocks and stores that result at position Row 3, Column M, “M3,” of Sheet2 of spreadsheet, “Stkanlzr.” Next, it determines whether the calculated index of DJA (by definition, =1) exceeds SPY's index. If so, the algorithm sorts all the stocks with indices less than the SPY index that must be less than one. These constitute low variability/low risk stocks. If SPY's index exceeds DJA's index of (1), the algorithm sorts all the stocks with indices between the DJA index and the SPY index. Under these conditions, these stocks may have indices less than and greater than one. These constitute low variability/low risk stocks. It places these stocks on the spreadsheet above SPY.

Next, the algorithm sorts the remaining stocks whose indices fall between the SPY and QQQ indices. These constitute medium variability/medium risk stocks. It places these stocks on the spreadsheet below SPY. It places QQQ on the spreadsheet below these medium risk stocks. The remaining stocks have indices greater than QQQ and represent high variability/high risk stocks. The algorithm then counts the number of stocks in each category (low, medium and high risk) and places that count on Sheet2 of spreadsheet, “Stkanlzr.” along Row 3, Columns J, K and L, “J3,” “K3” and “L3.” The user now has an accurate view of the relative variability of the stock selection and how the stock selection compares to easily understood references. Note the user will not detect any difference in the results or spreadsheet layout, even when DJA variability exceeds SPY's, except for a fractional SPY index less than one and all low risk stocks with indices less than one. An astute or professional user will recognize this result as indicative of unusual market conditions. The unusual market conditions may indicate a particularly auspicious time to invest in stocks with low variability/risk.

Solution Block 2

(FIG. 4, Steps 422 to 436,
FIG. 5, Steps 522 to 532 &
FIG.6, Steps 622 to 632)

Block 2 contains 4 distinct algorithms:
1) An algorithm that reads the state of module completion at the initiation of the processing Block, marks the completion of the Block, and calculates the number of inputs;
2) An algorithm to request additional input information from the user;
3) An algorithm that performs summary calculations to set limits to parameters specified by the user, (marketing/ sales budget allocation or portfolio variability risk acceptance)
4) An algorithm that completes the spreadsheet layout, installs fundamental equations for a linear program (LP), calls the LP solution technique, seeks a Sensitivity Analysis from the LP, examines the Sensitivity Analysis for appropriateness, alerts the user in the case of inappropriateness and ceases module operation.
   Algorithm to Determine the Module's State of Completion and to Count Inputs

Marketing Solution Module

To determine the state of completion of the module, an algorithm (FIG. 4. Step 422) examines location “E3” on Sheet2 of the spreadsheet, “Remake.” If it finds the value “1” at “E3” on the spreadsheet, the second block commences processing at Step 424. If Step 422 finds the value “2” at “E3” the second block continues processing at Step 436. At the conclusion of the second Block's processing, Step 442 adjusts “E3's” value on Sheet2 to “3”. If Step 422 finds a value greater than “2” at “E3” it skips processing to Step 446.

To determine the correct number of products, inventoried ingredients and non-inventoried ingredients an algorithm (FIG. 4, Step 422) searches for the term, “Products” on Sheet2 of “Remake.” The algorithm, after determining the location of the term “Products,” adds one more row and then searches by counting columns to the right to find the bold italic term “Subtoot2.” The count to “Subtoot2” indicates the total number of ingredients plus one (1), including the two potential substitutes plus the marketing budget. After locating “Subtoot2,” the algorithm returns to the column containing “Products” and searches by counting columns to the right and adding the number of columns containing plain italic characters. This total indicates the count of non-inventoried ingredients. The count of inventoried ingredients equals the total minus the non-inventoried count minus the two substitutes minus one (1) to allow for the marketing budget.

The use of this algorithm necessitates that a user has no input to the layout of the solution module. The user foregoes preferences about looks, for the sake of simplicity of use. Leaving the count as a variable, in the solution module, permits the module to cover a wide range of problems with the same solution process.

Portfolio Management Module

To determine the state of completion of the module an algorithm (FIG. 5. Step 522) examines position “E3” on the spreadsheet, “Stkanlzr”. If it finds the value “1” at “E3” on the spreadsheet, the second block commences processing at Step 524. If Step 522 finds the value “2” at “E3” the second block continues processing at Step 532. At the conclusion of the second Block's processing, Step 532 adjusts “E3's” value to “3”. If Step 532 finds a value greater than “2” at “E3” it skips processing to Step 548.

Another algorithm (FIG. 5, Step 522) calculates the number of stocks. The algorithm searches for the term, “Stock Symbol” on Sheet2 of the spreadsheet, “Stkanlzr.” After finding the term, it adds 4 rows and begins character recognition of the fifth row and each succeeding row and counting the rows until it detects an empty row.

Stock Shorting Module

To determine the state of completion of the module, an algorithm (FIG. 6, Step 622) examines position “E3” on the spreadsheet, “Stkshortr”. If it finds the value “1” at “E3” on the spreadsheet, the second block commences processing at Step 624. If Step 622 finds the value “2” at “E3,” the second block continues processing at Step 632. At the conclusion of the second Block's processing, Step 632 adjusts “E3's” value to “3”. If Step 632 finds a value greater than “2” at “E3,” it skips processing to Step 648.

Another algorithm (FIG. 6, Step 622) calculates the number of stocks. The algorithm searches for the term, “Stock Symbol” on Sheet2 of the spreadsheet, “Stkshortr.” After finding the term, it adds 4 rows and begins character recognition of the fifth row and each succeeding row and counting the rows until it detects an empty row.

Algorithms Seeking Additional Input from the User

Marketing Solution Module

In FIG. 4, Steps 424 and 428 request additional input from the user concerning the ratios of PMS output per unit of ingredient input, the prices for products or PMS's and the prices for ingredients. Additionally, the algorithm for Step 424 inquires how the user wishes to input the ratios: manually or by database such as a spreadsheet or a pre-existing marketing module solution. After determining the method of ratio input, the algorithm, at Step 424, accepts the ratios, analyzes them for degeneracy, and at step 426 begins the layout of the models on “Remake.” Some Linear Program solution techniques cannot solve LP setups that contain degeneracy. “Degeneracy” occurs when the ratios of ingredients for one product represent multiples for another product. For example, a six-ounce container of product and a twelve-ounce container of product do not represent different products, but rather different sizes of the same product. To enter them as different products would cause degeneracy. If the algorithm detects degeneracy, it warns the user of the problem, and offers the user the opportunity to adjust one or the other group of ratios to alter the ingredient mix. If the user declines to adjust the ratios, the algorithm notifies the user that the input consists of an impossible condition and that the module will cease operation and will shut down.

Portfolio Management Module

In FIG. 5, Step 524 requests additional input from the user concerning earnings per share and dividends per share for each stock selection on a semi-annual basis. Using a six-month period focuses on the most up-to-date earnings performance. An algorithm in Step 524 requests the user to input the amount of investment capital available and the amount of that capital the user can afford to lose. The contingency loss amounts to 10 percent of the investment capital. The algorithm permits a loss up to 50 percent of investment capital. The 50 percent upper limit represents a useful limit for users of the portfolio management solution module. Anyone willing to risk losing more than 50 percent of his or her investment would not benefit from using the portfolio management solution module.

Additionally, the algorithm for Step 524 inquires how the user wishes to input the data: manually or by database. At Step 526, the algorithm begins the layout of models on “Stkanlzr.”

Stock Shorting Module

In FIG. 6, Step 624 requests additional input from the user concerning earnings per share and dividends per share for each stock selection on a semi-annual basis. Using a six-month period focuses on the most up-to-date earnings performance. An algorithm in Step 624 requests the user to input the amount of investment capital available and the amount of that capital the user can afford to lose. The contingency loss amounts to 10 percent of the investment capital. The algorithm permits a loss up to 50 percent of investment capital. The 50 percent upper limit represents a useful limit for users of the stock shorting solution module. Anyone willing to risk losing more than 50 percent of his or her investment would not benefit from using the stock shorting solution module. Additionally, the algorithm for Step 624 inquires how the user wishes to input the data: manually or by database. At Step 626, the algorithm begins the layout of models on “Stkshortr.”

Algorithms Informing Users about Parameter Limits, Based on Summary Calculations

Marketing Solution Module

An algorithm (FIG. 4, Steps 430 and 432) uses the ratios and demand forecasts to calculate the amount of ingredients required to meet demand. It then compares that requirement with the inventories of ingredient to calculate an additional backorder of ingredients required to meet demand. After the calculations, the algorithm informs the user of the amounts to backorder for each ingredient to meet demand forecasts. After the user approves the backorder, the algorithm completes the layout of the spreadsheet less the marketing/sales budget for each product. It then calculates, at Step 434, preliminary estimates of gross margin for each product and for the overall business. It then queries the user concerning how the user wishes to allocate the marketing/sales budget, either on a total basis or on a unit basis for each product. It indicates the total amount available for the budget with the calculation representing 90 percent of the total gross margin. This limit permits coverage for additional general and administrative expenses not included in the module's formulation of gross margin.

After the user indicates a preference for a total basis or a unit basis for each product, the algorithm asks what percentage of the gross margin the user will allocate to the budget. The user can select any percentage less than 90 percent of the preliminary estimate of gross margin. After the user enters a percentage allocation for the budget, the algorithm confirms that entry. After the user confirms the algorithm's confirmation, the algorithm proceeds to formulate the budget. If the user had indicated a preference for a budget allocated on a total basis, the algorithm multiplies the gross margin of each product by the user specified percentage to obtain the marketing/sales budget for each product. If the user specified a preference for a unit basis, the algorithm displays the multiplication result discussed above and asks the user whether to enter that amount, or less. A larger budget means the budget would exceed the percentage limit the user just specified. After the user specifies an acceptable per-unit budget, the algorithm confirms the value.

Portfolio Management Module

An algorithm (FIG. 5, Step 524) asks the user's preference to limit variability in stock price fluctuations. The algorithm suggests a variability limit of the selected stocks. The user can select variability with the choice limited by the state of the stock market and the user's stock selections.

Conservative Stock Selections

If the stock market has the usual progression of variability (for example, in the US, QQQ>SPY>DJA) and the user makes stock selections with an average variability between SPY and QQQ, the user can specify a variability up to 10 percent greater than the average for the user's stock selection. This permits consideration of all stock selections but places a reasonable limit on variability. Using a variability constraint greater than this level makes the constraint too large for any relevance to the portfolio analysis.

Intermediate Variability Stock Selections

If the stock market has the usual progression of variability (or even the unusual variability progression (QQQ>DJA>SPY)) and the user makes stock selections with an average variability greater than SPY but less than QQQ, the user can specify a variability constraint up to 25 percent greater than the average for the user's stock selection. This permits consideration of all the user's stock selections but places a reasonable limit on variability. Using a variability constraint greater than this level makes the constraint too large for any relevance to the portfolio analysis. Conversely, leaving the constraint at 10 percent greater than the stock selection average would excessively constrain the portfolio selection. If the user chooses a very low variability, the module will create a portfolio with small investments in few stocks. If this occurs, the user probably would re-use the module again but select a larger variability.

High Variability Stock Selections

No matter what the state of the stock market, if the user specifies a portfolio with an average variability exceeding QQQ's variability, the algorithm notifies the user that the selections consist of “Hi Risk Stocks.” In this situation, the algorithm limits the user to specifying a variability constraint up to 50 percent greater than the variability for QQQ. This permits consideration of many stock selections but places a reasonable limit on variability that bears some relationship to the overall stock market. If a user only selects stocks with volatilities 50 percent greater than QQQ, the user over-rides the usefulness of the portfolio management module and enters the realm of gambling. Under this condition, a variability limit of one and one-half times QQQ's variability will act as a binding constraint forcing a solution of no investment. Hopefully the user will recognize the extreme variability of the stock selections, act sensibly and consider a different stock mix with a lower average variability.

Unfortunately, many investors motivated by greed, rather than prudence, expect high investment returns without realizing or accepting the risks associated with the potential for high returns. This selection should represent a wake-up call, to the uninitiated, that high risk accompanies high reward. The other risk constraint, concerning how much invested capital a user can afford to lose, represents a fallback provision that can save the investor from himself or herself if the user honestly addresses tolerance for loss. If users accept unreasonably high variability and large investment loss limits, they may experience a very expensive education.

Stock Shorting Module

An algorithm (FIG. 6, Step 624) asks the user's preference to limit variability in stock price fluctuations; see explanation in the paragraph above.

Algorithms to Complete Spreadsheet Layout, Create and Solve an Initial Linear Program.

Marketing Solution Module

Eight general parameters affect marketing mix: (1) Product Market Segments (PMS), (2) Components to serve the PMS's, (3) the Ratio of PMS per unit Component Input, (4) Component Availability, (5) Demand Forecasts, (6) Prices, (7) Gross Margins and (8) the Marketing/Sales Budget. For simple businesses, Products serve as proxies for PMS's and ingredients serve as components and inventories serve as component availability. For simplicity of explanation, assume a simple business and the terminology of Products, ingredients and inventories. A complex business requires the more general terminology of PMS and components.

PMS's consist of weighted averages of sales to target segments, components consist of weighted average costs of ingredients to serve the target segments and component availability consists of weighted averages of ingredient inventories. The Optimal Quantities to Sell for each product constitute the “Change Variable” equations (different numbers) for the optimal marketing mix to support the maximum Gross Operating Margin.

Product operating margins equal the difference between product prices and the unit costs to produce, sell and market each product. Gross Operating Margin equals the array product from Optimal Quantities to Sell multiplied by Product operating margins. The array's number of elements equals the number of products.

According to standard linear programming terminology, the LP “Objective Function” equals the Gross Operating Margin.

“Constraint Equations” consist of the difference between the availability and the consumption or usage of ingredients to meet sales. Specifically, ingredients remaining after usage equal the difference between the total of an array multiplication (of ratios of usage of an ingredient by each product times the Optimal Quantities to Sell for the products) subtracted from the amount of the ingredient available. This total requires determination for each ingredient. The amount remaining must equal or exceed zero. The amount used must equal or exceed zero. The quantity of product sold must equal or exceed zero.

Thus, the number of “Constraint Equations” comprises (array equations equal to the number of ingredients) plus (array equations to specify greater-than-zero results to the LP solution technique). For ten (10) ingredients, that totals to thirteen (13) equations.

An algorithm (FIG. 4, Step 436) uses the count of products, inventoried and non-inventoried, and a prescribed format completes spreadsheet layouts of models on Sheet2 and Sheet3 of the spreadsheet “Remake.”

The algorithm further uses the count, for these variables, to create the appropriate equations governing the model and places them at the appropriate locations on the spreadsheet. It then takes the numerical results from the statistical analysis (base forecasts and uncertainties) and input data and calculates results for those equations. It then creates the required array equations and places them in the appropriate locations. It then creates the required “Objective Function,” “Change Variable” and “Constraint Equations” and places these equations in the LP solution technique, and formulates a preliminary LP solution.

The algorithm checks the appropriateness of the LP solution's Sensitivity Analysis. If it finds an inappropriate Sensitivity Analysis, it notifies the user and requests the user to manually operate the LP Solution technique to produce the correct Sensitivity Analysis.

If the user must perform a manual run for the Sensitivity Analysis, Step 436 enters a “2” on Sheet2 in location “E3” and then ceases the operation of the solution module. If the algorithm determines a correct Sensitivity Analysis it enters a “3” on Sheet2 at location “E3” and moves to the next processing Block at Step 438.

Portfolio Management Solution Module

An algorithm (FIG. 5, Step 528) utilizes the results of the statistical analysis (Step 518) to calculate the Reward/Risk ratios for the stocks. The Reward/Risk ratio equals the potential investment gain divided by the potential investment loss. Potential investment gain equals forecasted upside stock price, minus the current stock price. Potential investment loss equals the current stock price, minus the forecasted downside stock price. The algorithm stores these results for later use in the solution module.

Three general parameters affect portfolio selection: (1) Risk, (2) Reward and (3) Investment Capital. The Investment Capital parameter constitutes the “Change Variable” equations (different numbers) for the optimal investment for each stock. Risk splits into two sub-parameters consisting of: the amount of invested capital the user can afford to lose and the amount of stock price variability the user can afford to encounter. Reward splits into two sub-parameters consisting of:

dividends and

stock price appreciation.

Constraint equations for these 4 sub-parameters must address each stock individually, as well as in total. Therefore, a portfolio consisting of 13 stock picks (plus the two “index” stocks) requires [{(13+2)×4}=60] sixty individual equations. Additionally, the linear program requires constraint on the sums of each of these 4 parameters or 4 vector (or array) product equations, consisting of the product of each constraint parameter times the “Change Variable” equations (numbers). For a 13-stock portfolio, the constraint vector would consist of 15 elements. For the sum of capital invested in particular stocks, the 4-array product equations produce: the Total Reward from stock price appreciation, the Total Dividend from the selected stocks, the Total Potential Loss from investing in selected stocks and the Total Variability (Price Change Risk) for the selected stocks.

Finally, the “Objective Function” equation consists of the sum of Total Dividends plus Total Stock price appreciation (mathematically the sum of the two array product equations covering Reward). Thus the layout of the linear program for 13 stocks requires 65 linear equations plus the 15 “number” equations of “Change Variables.” Additionally, the mathematical tool that solves the linear program requires equations for instructions. These instruction equations define the location of the “Objective Function”, “Change Variables” and “Constraint Equations,” as well as dictate that solutions consist of zero or positive results. The count of these instruction equations varies from 6 to 9, depending upon the block in the solution module. Thus, a basic linear program for a 13-stock portfolio requires between 86 to 89 equations to define a solution for an optimized portfolio. Fifty iterations to solve the linear program equates to the solution of 4300 to 4500 equations.

Using the count of stocks determined at Step 522, the algorithm at Step 530 creates the appropriate equations for the linear programming model and uses a prescribed format to complete the spreadsheet models on Sheet2 and Sheet3 of the spreadsheet “Stkanlzr.” It further uses the count, for these variables, to create the appropriate equations governing the model and places the equations at the appropriate locations on the spreadsheet. It then takes the numerical results from the statistical analysis (base forecasts and uncertainties) and input data and calculates results for the spreadsheet equations. It then creates the required array equations and places them in the appropriate locations. It then creates the required “Objective Function”, “Change Variable” and “Constraint Equations” and places them in the LP Solution Technique and formulates a preliminary LP solution.

The algorithm checks the appropriateness of the LP solution's Sensitivity Analysis. If it finds an inappropriate Sensitivity Analysis, it notifies the user and requests the user to manually operate the LP Solution technique to produce the correct Sensitivity Analysis. If the user must perform a manual run for the Sensitivity Analysis, Step 534 enters a “2” on Sheet2 at location “E3” and then ceases the operation of the solution module. If the algorithm determines a correct Sensitivity Analysis it enters a “3” on Sheet2 at location “E3” and moves to the next processing Block at Step 536.

Stock Shorting Module

An algorithm (FIG. 6, Step 628) utilizes the results of the statistical analysis (Step 618) to calculate the Reward/Risk ratios for the stocks. The Reward/Risk ratio equals the potential investment gain divided by the potential investment loss. Unlike the Portfolio Management Module, the Stock Shorting Module treats Dividends as a loss, not a gain. The stock shorter might have to make dividend payments out-of-pocket to the investor who actually owns the borrowed shares of stock. For further explanation of the Stock Shorting algorithms, review the paragraph above and substitute “Stkshortr” for “Stkanlzr” and add 100 to the step values.

Solution Block 3

(FIG. 4, Steps 436 to 456,
FIG. 5, Steps 532 to 556 and
FIG. 6, Steps 632 to 656)

Block 3 contains 4 distinct algorithms:
1) An algorithm reads the state of completion of the module at the initiation of the processing Block, marks the completion of the Block and counts variables;
2) An algorithm alerts the user concerning the implications of the Sensitivity Analysis;
3) An algorithm iterates the simple LP according to Sensitivity Analysis implications;
4) An algorithm querying the user for adjustments to the simple LP.
   Algorithms which Determine the Module's State of Completion and which Count Inputs

Marketing Solution Module

If the user had to manually call the LP solution technique, upon restart, Step 422 sends the module to Step 436 to continue the solution process. Otherwise, Step 422 sends the module to step 446 to determine the state of completion of the module. An algorithm, at step 446, examines location “E3” on Sheet2 of the spreadsheet, “Remake.” If it finds the value “3” at “E3” on Sheet2 of the spreadsheet “Remake,” the third block commences processing at Step 448. At the conclusion of processing, Step 456 places a value of “4” on Sheet2 at location “E3”. If Step 446 finds a value greater than “3” in “E3” it proceeds to Step 458.

If the user had to manually call the LP solution technique, the module on restart at Step 422 determines the correct number of products, inventoried ingredients and non-inventoried ingredients. Otherwise an algorithm (FIG. 4. Step 446) searches for the term, “Products” on Sheet2 of the spreadsheet, “Remake.” The algorithm after determining the location of the term “Products” adds one more row and then searches by counting columns to the right to find the bold italic term “Subtoot2.” The count to “Subtoot2” indicates the total number of ingredients plus one (1), including two potential substitutes, plus the marketing budget. After locating “Subtoot2,” the algorithm returns to the column containing “Products” and searches by counting columns to the right and adding the number of columns containing plain italic characters. This total indicates the count of non-inventoried ingredients. The count of inventoried ingredients equals the total minus the non-inventoried count minus the two substitutes minus one (1) to allow for the marketing budget.

Portfolio Management Module

If the user had to manually call the LP solution technique, upon module restart, Step 522 sends the module to Step 532 to continue the solution process. To determine the state of completion of the module, an algorithm (FIG. 5, Step 532) examines position “E3” on the spreadsheet, “Stkanlzr”. If it finds the value “3” on Sheet2 at location “E3” on the spreadsheet, the second block commences processing at Step 548. At the conclusion of processing, Step 556 places a value of “4” in “E3”. If Step 532 finds a value greater than “3, in “E3” it proceeds to Step 558.

If the user had to manually call the LP solution technique, the module, upon restart at Step 532, uses an algorithm (FIG. 5, Step 532) to calculate the number of stocks by searching for the term, “Stock Symbol” on Sheet2 of the spreadsheet, “Stkanlzr.” After finding the term, it adds 4 rows, begins character recognition of the fifth row and each succeeding row, and counts the rows until it detects an empty row.

Stock Shorting Module

For further explanation of the Stock Shorting algorithms to count stocks, review the paragraph above and substitute “Stkshortr” for “Stkanlzr” and add 100 to the reference number of each step, e.g. step 532 becomes step 632.

Algorithms Alerting the User to the Implications of the Sensitivity Analysis

Marketing Solution Module

The algorithm (Step 438) examine the linear program's Sensitivity Analysis. At first it examines the required increase in a product's gross margin to make it an equivalent “contributor” to overall business gross margin. Note that gross margins could exist such that all products contribute to the business. If so, the algorithm notifies the user of this situation. It might indicate a lack of upside or downside gross margin sensitivity. The count of upside or downside gross margin triggers has no relationship to the number of products, except that the maximum possible count of gross margin adjustments will be limited to less than twice the product count. Because the LP formulation provided all ingredients to meet demand, only marketing constraints, not production constraints, affect the solution.

Effectively, the required gross margin increase for a product represents the “opportunity cost” attributable to making and selling the product. If products exist with “opportunity costs”, the business would benefit by devoting resources to the promotion and sales of other products.

The algorithm, at Step 440, notifies the user of the less than optimal gross margin contribution of the product and indicates the per-unit cost to the business for supporting the product. The user can choose to offset “opportunity cost” by either raising prices or cutting expenses. The algorithm focuses on expense cuts. The algorithm (FIG. 4, Step 442) examines each gross margin increase and decrease in the Sensitivity Analysis that affects the potential contribution of each product. Therefore, the algorithm must examine the Sensitivity Analysis and determine if and what price change would possibly change a product's contribution to the business. The algorithm's examination consists of determining if the upside or downside gross margin increase exceeds $0.01 but does not exceed $10000. This range excludes situations where unrealistically large gross margin increases must occur to make the product an optimal contributor to the business. The algorithm records the count of upside gross margin increases, and adjusts the current product prices for the increases. It performs the same for downside prices.

Portfolio Management Module

If the algorithm detects a “3” at position “E3” on the solution spreadsheet, the algorithm recognizes the user manually ran the LP analysis at Step 534 to obtain a Sensitivity Analysis for a LP with limited constraint equations. It proceeds to examine the linear program's Sensitivity Analysis (Step 536). It examines the Sensitivity Analysis to determine whether an incremental price change exists (whatever its probability of occurrence) that would make the stock a portfolio candidate, or remove its candidacy. Note that current stock prices could exist such that all stock selections become portfolio candidates. In this situation, the Sensitivity Analysis would indicate NO upside price sensitivity.

However, price drops could remove a stock's candidacy. In the situation that some prices make portfolio candidates for a few stocks, the Sensitivity Analysis would indicate some upside price variability. If upside price variability exists, the algorithm adjusts the price to the upside trigger. It then compares that price to the statistical analysis' high side price variability. For the suggested upper variability of 0.95, less than a 5 percent probability exists, that the high side price or greater will occur. If the stock price trigger exceeds the high side price, then the algorithm notifies the user of this unlikely event. In some cases, the user would have to sell the stock at this high price, as well as purchase it at a low price, to make an investment gain equivalent to the gain afforded by other stocks. The algorithm compares the low buy price to the statistical analysis' low side price variability. If the statistical analysis' low side price exceeds the indicated buy price, the algorithm, at step 538, notifies the user of this unlikely event, in combination with the necessity of achieving the unlikely selling price. The algorithm records, at Step 540, whether or not a stock has some reasonable probability of contributing to the portfolio.

At Step 542, the algorithm asks about the user's current portfolio, requesting identification of the stocks, the purchase prices, and the amount originally invested in each stock and the user's requirement for dividends.

Stock Shorting Module

If the algorithm detects a “3” at position “E3” on the solution spreadsheet, the algorithm recognizes that the user manually ran the LP analysis at Step 634 to obtain a Sensitivity Analysis for a LP with limited constraint equations. It proceeds to examine the linear program's Sensitivity Analysis (Step 636). It examines the Sensitivity Analysis to determine whether an incremental price change exists (whatever its probability of occurrence) that would make the stock a viable candidate for a short sale. Note that prices could exist such that all stock selections make acceptable stock shorting candidates. In this situation, the Sensitivity Analysis would indicate NO downside price sensitivity.

However, price increases could remove a stock's shorting candidacy. In the situation that some prices make portfolio candidates for a few stocks, the Sensitivity Analysis would indicate some downside price sensitivity. If downside price sensitivity exists, the algorithm adjusts the price to the downside trigger. It then compares that price to the statistical analysis' low side price. For the suggested upper variability of 0.95, less than a 5 percent probability exists that the low side price or less will occur if the stock price trigger is less than the low side price. The algorithm, at Step 638, notifies the user of this unlikely event. In some cases, the user would have to sell the stock at this high price, as well as purchase at a low price, to make a short sale gain equivalent to the gain afforded by other stock short sales. The algorithm compares the low sell price to the statistical analysis' low side price variability. If the statistical analysis' low side price is less than the indicated sell price, the algorithm at Step 638 notifies the user of this unlikely event, in combination with the necessity of achieving the unlikely buy price. The algorithm at Step 640 records whether or not a stock has some reasonable probability of contributing to the short sale portfolio. At Step 642, the algorithm inquires about the user's current portfolio of short sale stocks, the shorting prices and amount originally realized by the sale of each stock and the user's willingness for dividend re-imbursement expenditures.

Algorithm to Iterate (Repeated Runs) the Simple LP Formulation with Minimum Constraints

Marketing Solution Module

The algorithm (FIG. 4. Step 448) takes the adjusted price for each product, substitutes it into the linear program, solves the LP and records the “solution”: which products the LP includes on a list of products recommended to be offered for sale. Note this LP formulation does not conform to market demands. The solution simply attempts to find whether the product can become a robust “business contributor” relative to other products. It repeats this process, for all the possible gross margin changes indicated by the Sensitivity Analysis. For each product, the algorithm counts the number of occurrences in the LP solutions and records it. This algorithm then indicates to the user, at Step 450, how the product weathered the gross margin changes. Some products remain viable contributors under a wide range in gross margin (price) adjustments.

The algorithm denotes any product a “Contributor” if it maintains its place in the sales-mix for more than 90 percent of the combinations of gross margin (price) variations. Conversely, the algorithm denotes products with fewer than 10 percent occurrences as “Detractors.” Any product with more than 10 percent but fewer than 90 percent occurrences receives no special designation. The algorithm records these results for subsequent use in the solution module.

Portfolio Management Module

The algorithm (FIG. 5, Step 548) examines each stock price increase and decrease in the Sensitivity Analysis that affects the potential contribution of each stock to the portfolio. Note that prices could exist such that all stocks contribute to the portfolio mix. If so, the algorithm notifies the user of this situation. It might indicate a lack of upside or downside stock price sensitivity. The count of stock selections for a portfolio has no relationship to the count of price changes of interest from a Sensitivity Analysis except that the maximum possible count of price changes will be limited to less than twice the stock count. Therefore, the algorithm must examine the Sensitivity Analysis and determine if a price change, and what price change, would possibly change a stock's inclusion in the portfolio.

The algorithm's examination consists of determining if the upside or downside price increase exceeds $0.01 but does not exceed $10000. This range excludes situations where unrealistically large price increases must occur to include the stock in the portfolio. The algorithm records the count of upside price increases and adjusts the current stock prices for the increases. It performs the same for downside prices. Next the algorithm takes the adjusted price for each stock, substitutes it into the linear program, solves the LP and records the solution of which stocks the LP includes in the portfolio. It repeats this process for all the possible stock price changes indicated by the Sensitivity Analysis. For each stock, this algorithm counts the number of occurrences in the LP solutions and records it. An algorithm in the final block of the portfolio management module uses this result in its analysis. (For 50 iterations of the possible 28 price adjustments of a reference 13 stock portfolio would require the solution of 120,000 to 126,000 equations.) At Step 550, the algorithm compares the prices required for stock contribution to the portfolio from step 548 and the probabilities of price occurrence from the statistical analysis. At Step 552, the algorithm stores these prices and probabilities.

Stock Shorting Module

For further explanation of the Stock Shorting algorithms to count and adjust stock prices, review the paragraph above and substitute “Stkshortr” for “Stkanlzr” and add 100 to the reference numeral for the respective step. In the case for selecting stocks to short, the algorithms compare the probabilities of low prices with price drops required to make a shorted stock a “contributor” to the shorting portfolio.

Algorithms Adjusting the Simplet Linear Program (LP)

Marketing Solution Module

An algorithm (FIG. 4, Step 452) adjusts the simple LP on Sheet2 by utilizing the implications of the Sensitivity Analysis to create additional equations to apply as additional constraints. (This algorithm does not affect the solution on Sheet3. Sheet3 continues with the simple LP solution to offer a comparison between a simple type of LP solution and the more sophisticated one created by the inclusion of expert analysis contained on Sheet2.) The algorithm examines whether a product acts as a contributor or detractor to the business. The algorithm takes the median demand forecast and adds the large demand variability determined by the statistical analysis. For a selection of 0.95 during the statistical analysis, the adjusted demand equates to a customer service level of 95 percent (or meeting customer demand 95 percent of the time). The algorithm copies, from the Sheet1 statistical analysis results, the median demand forecast and subtracts the small variability. For a selection of 0.68 during the statistical analysis, the adjusted demand equates to a customer service level of 32 percent (or meeting customer demand 32 percent of the time). It then uses these revised demand forecasts as additional constraints. The 95 percent service level dictates the upper bound on the “Change Variable” equations. The 32 percent service level dictates the lower bound on the “Change Variable” equations. The algorithm adds two control equations to the LP solution technique bounding the solution to the “Change Variables” to within the upper and lower bounds. The algorithm (Step 454) then commands the LP solution technique to re-solve the LP. The solution consists of “Change Variables” for quantities to sell of products where:
“Contributor” products meet customer service levels between 50 and 95 percent but usually closer to 95 percent;
“Detractor” products meet customer service levels between 32 and 95 percent but usually less than 50 percent and
Other products meet customer service levels between 32 and 95 percent but usually closer to some value greater than 50 percent.

By supporting “contributor” products more than “detractor” products, the Total Business Profitability usually improves by about 5 to 20 percent, with 10 percent improvement being the most common result. The algorithm (Step 456) displays the improved results next to the base results on Sheet2 of spreadsheet, “Remake” in locations “F3” through “G6”. The comparison includes Gross Margin, Resource Utilization and Total Profitability comparisons. The algorithm (Step 458) places a “4” in location “E3” of Sheet2 of “Remake.”

Portfolio Management Module

Before adjusting the simple LP layout and equations, the algorithm (FIG. 5, Step 554) challenges the user to use any basis or methodology to make investments in any of the selected stocks. After the selection the algorithm calculates and records the results of the challenge at positions “F4” through “F7” of Sheet2 of “Stkanlzr.” Results include: the Reward/Risk ratio, the portfolio variability, the maximum loss and the maximum cash gain. Alternatively, if the user declines to make any investment decisions, the algorithm simply distributes investments equally among all the stocks. This represents the simplest method for investment allocation. The algorithm records the results of the challenge at positions “F4” through “F7” of Sheet2 of “Stkanlzr.”

Next, the algorithm queries the user concerning any existing investments in the selected stocks. If the user has stocks, the algorithm requests and records information concerning the purchase price and the amount invested in the stock.

Finally, the algorithm adds to and adjusts the simple LP's equations. Initially the algorithm queries the user concerning a preference for the maximum fraction a stock can constitute in the portfolio. The algorithm limits the maximum fraction to between (0.15) and (0.36). Proper portfolio diversification requires a portfolio of at least 5 to 7 stocks. With 7 stocks, each stock's fraction would equal ( 1/7) one-seventh or a fraction of approximately (0.15). This constitutes the reason for the lower fraction. An upper limit of (0.36) permits a user to approximately double the limit for stocks with particularly strong investment potential. The selection of (0.36) provides a number with large factorial possibility but approximately double the recommended limit. (The numbers 2, 3, 4, 6, 9, and 12 can divide 36. This helps numerical processing of the solution module.) The algorithm suggests the minimum limit (0.15) to the user. After the user selects a fraction in the permitted range, the algorithm confirms that selection with the user. The algorithm then creates constraints for each stock with the format: constraint=[(user selected fraction) minus (optimum investment in individual stock divided by total investment)] and installs the constraints on the spreadsheet. The number of additional constraint equations equals the number of stocks.

After placing equations constraining the stock selection to a maximum fraction on Sheet2 and Sheet3, the algorithm continues but only focuses on Sheet2. The subsequent algorithm adjustments to the solution on Sheet2 do not affect the solution on Sheet3. Sheet3 continues with the simple LP model to offer a comparison between the simple LP model and the more sophisticated one exhibited on Sheet2 and created by the inclusion of expert analysis.

Next, the algorithm creates constraint equations for each stock by utilizing:
Reward/Risk Ratios,
the implications of the Sensitivity Analysis,
relationships between stock prices and probabilities of occurrence and
if any, the user's current holding and investment in stocks.

This algorithm contains decision rules introduced without a developed theoretical basis. Conventional wisdom holds that the open-market bidding system for stocks operates efficiently. In the efficient market, pertinent information affecting stock outlook disperses throughout the market quickly, with the consequence of stock price re-appraisal, regardless of the vested interests of past pricing. The efficient market theory conflicts with anecdotal information concerning human behavior of: denial, distortion and reticence to accept bad news and stock trading losses. This algorithm builds on the anecdotal information and assumes that historical prices have a substantial impact on current and future prices.

The algorithm creates equations for stock prices within a trading range and equations for stock prices piercing established trading ranges. For stock prices occurring within established trading ranges, the algorithm creates equations with the format of: (calculated upside fraction limit for an individual stock) minus (optimum investment in individual stock divided by total investment), if the user hold no current investment in the stock or

(optimum investment in individual stock divided by total investment) minus [(weight factor) times (current-individual stock investment divided by total investment)], if the user holds a current investment in the stock.

If the user hold no current investment in the stock, the calculated upside fraction limits reflects the following considerations:
Reward/Risk ratio (R/R ratio) for a stock
   For a (R/R ratio) less than 1, the fraction limit automatically equals zero
   For a (R/R ratio)>=than 1 but <3, a fraction limit equals (0.16 divided by the square root of the number of stocks in the user's selection) multiplied by a weight factor,
   For a (R/R ratio)>=3 but <5, a fraction limit equals (0.325 divided by the square root of the number of stocks in the user's selection) multiplied by a weight factor,
   For a (R/R ratio)>=5, a fraction limit equals (0.65 divided by the square root of the number of stocks in the user's selection) multiplied by a weight factor, the consistency of the stock's selection during the LP Sensitivity Analysis and the probabilities of occurrence:
   if the stock occurs in less than two Sensitivity Analysis portfolios, the weight factor equals the square root of the number of occurrences plus (two minus the count of ranges beyond the upper and lower variability of 95 percent); for example, if the stock occurred in one portfolio but needed a purchase with less than a 5 percent probability of occurrence and a selling price with less than a 5 percent probability of occurrence the weight factor would equal (1^{1/2}+0=1) one;
   if the stock occurs in two or more Sensitivity Analysis portfolios, the weight factor equals two plus (two minus the count of ranges beyond the upper and lower variability of 95 percent), for example, if the stock occurred in 5 portfolios and did not require a sell price or purchase price with less than a 5 percent probability of occurrence the weight factor would equal (2+2=4) four.

Depending upon: a count of stocks (between 5 and 25); the range of reward/risk ratios; stock portfolio consistency and price probabilities, the above algorithm can formulate, for each stock, any one of 420 different equations. If the LP solution technique handled more than 25 stocks, the algorithm might require adjustment to account for a larger number of stocks. The trigger factors of (0.16), (0.325) and (0.65) reflect an expert evaluation of the contributory nature of stocks with various (R/R) ratios and the requirement to broaden a portfolio to minimize risk. Proper portfolio diversification requires a portfolio of at least 6 to 7 stocks although it is recommended to investigate a minimum of 15 stocks. With 7 stocks, each stock on average represents less than ( 1/7) or (0.15) of the portfolio. Increasing the weighting of stock according to a Reward/Risk ratio series of a base value, double base value and finally doubled double base value and considering that the solution model does permit a minimum number of stocks as low as 5, the series (0.16), (0.325) and (0.65) provides a series of trigger factors consistent with the numbers of stocks subject to analysis and the greatest weight factor (4). At the extreme of a portfolio with as few as 5 stocks and a stock with a high Reward/Risk ratio and a weight factor of 4, the upper bound fraction would permit a stock fraction of (0.52) [=(0.65/5)×(4)] in the portfolio. However, this upper limit represents a non-binding constraint. The algorithm's previous constraints (determined from user's fraction limit) confines the maximum stock fraction to (0.36) and makes larger fractions (such as 0.52) irrelevant.

If the user holds a current investment in the stock, the calculated weight factors reflect the consideration of the Reward/Risk ratio (R/R ratio) for a stock:
For a (R/R ratio) less than 1, the weight factor automatically equals zero
For a (R/R ratio)>=than 1 but <3, the weight factor equals (0.5 times the current stock investment divided by total investment available)

1For a (R/R ratio)>=3, the weight factor equals (one times the current stock investment divided by total investment available).

These weight factors permit a reasonable range for consideration of whether the stock represents an optimal investment, as well as its role as an existing investment. The difference between the (R/R) trigger of 3 for an existing investment and a 5 for a stock not yet purchased, takes into account the taxes and selling transaction costs associated with the existing investment. Once in a portfolio, the (R/R) hurdle (3), to keep the stock, should fall below the (R/R) hurdle (5) required for addition to the portfolio. If the (R/R) hurdle falls below (3), the weight factor falls to one-half (0.5), in consideration of possibly selling some of the existing investment.

A (R/R) ratio below 3 represents an investment with a potential return of less than $3 for every dollar at risk of loss. This represents a barely attractive investment. The weight factor automatically equals zero if the (R/R) ratio falls below one dollar ($1). In this situation, the user faces a greater risk of losing money than making money from the stock investment. It seems hard to imagine any rational user would prefer a money losing investment to a money making one. For stock prices occurring above or below established trading ranges, the algorithm creates different equations that supersede the trading range equations. These additional equations reflect research on portfolio management results derived from the three previous blocks of analysis. The algorithm creates equations with three different formats:
lock the stock out of the portfolio,
lock the stock into the portfolio or
discard consideration of the stock due to confusing stock price distribution results.

The algorithm prioritizes the non-trading range equations over trading range equations. Non-trading range equations have two different objectives, depending upon whether the stock price exceeds the upper or lower trading range prices.

STOCK LOCK-OUT—If the price falls below the lower trading range boundary the algorithm develops an equation to remove consideration of the stock and forcing the stock investment to zero.

STOCK-IN Conversely, if the stock price exceeds the upper bound for a trading range, the algorithm creates an equation requiring a minimum stock investment. These equations reflect the shape of price distribution for the stock as well as its variability relative to the Dow Jones Industrial average. Their genesis reflects considerable research on the use of the solution modules and fine-tuning of the expert analysis portion of the algorithm in the determination of key coefficients. Discussion of the DECLINE equations follows below.

Without providing algebraic derivations, the following discussion encompasses the qualitative reasoning for the existence of the equations. To simplify the discussion and algebraic presentation, the discussion assumes the user selects the upper (0.95) and lower (0.68) set points for stock variability. Although mathematic logic would follow the path of broad to narrow constraints, simplified algorithm-programming dictates proceeding from narrow to broad constraint equations. For discussion purposes, variable names and symbols include: Current Stock Price=CP; Forecasted Stock Price=FP; Upper Forecasted Stock Price=UP; Lower Forecasted Stock Price=Plow; Minimum Variability of Stock price (at the lower (0.68) set point=Vₘᵢₙ; Maximum Variability of Stock Price at the upper (0.95) set point=Vₘₐₓ; Ratio of the Variability of the Stock Price to the Variability of the Dow Jones Industrial Average=Rᵣₑₗₐₜᵢᵥₑ Note in the Portfolio Management module: UP=FP+Vₘᵢₙ and P_{low}=FP−Vₘₐₓ

LOCK-OUT EQUATIONS adhere to the mathematical and logic formula:If CP/(FP+(Vₘᵢₙ×(1−Rᵣₑₗₐₜᵢᵥₑ))=<0.9508 force the stock from the portfolio. To achieve the lock out in the algorithm requires several programming equations. One equation evaluates the inequality to determine if the lock out applies. If it applies, a second equation sets an algorithm variable, zszrato, equal to zero. The algorithm then enters another equation setting the allowed percentage of stock in the portfolio equal to zszrato, minus the ratio of the amount invested in the stock relative to available invested funds. When the algorithm enters the final linear programming allocation of stock investment funds, any equation for a stock with zszrato equaling zero must set the stock investment to zero, to meet the linear programming constraints prohibiting negative investment values.

LOCK-IN EQUATIONS adhere to the mathematical and logic formula: When CP/FP>=1.0256 then include the stock in the portfolio. A price increase representing a differential between the current and forecasted prices of 2.56 percent within a one-week period indicates a major shift for a stock's price distribution. Furthermore, it indicates a substantial probability for a period of increasing prices. Consequently, the algorithm formulates several equations to force the stock into the portfolio.

First, the algorithm evaluates the equation to determine if the logic statement applies. If it applies, a second equation evaluates a value for an algorithm variable, zdzrato. zdzrato equals the maximum permitted ratio of any stock within the available invested funds as selected by the user multiplied by the ratio derived by 0.8 divided by the square root of the number of stocks considered for the portfolio. The value of 0.8 represents a compromise value sanctioning portfolios with 6 to 30 stocks. If the number of stocks considered for a portfolio were to exceed more than 30, the value 0.8 would have to increase.

A third equation determines if the value of zdzrato exceeds 0.05 and if so, sets zdzrato equal to 0.05. The algorithm then produces another equation equaling the ratio of the amount invested in the stock relative to available invested funds minus zdzrato. The reason for limiting the ratio of the stock to the total portfolio to 0.05 represents a minimum lower bound of 5 percent of the portfolio. When the algorithm enters the final linear programming allocation of stock investment funds, any equation for a stock with zdzrato equaling 0.05 must set the stock investment ratio to some value greater than or equal to 0.05 to meet the linear programming constraints prohibiting negative investment values.

DISCARD EQUATIONS supersede all other algorithm equations. Portfolio research with the portfolio management module indicates that, under certain conditions, the algorithm fails to adequately manage a stock portfolio. Consequently DISCARD EQUATIONS evaluate the conditions for unsatisfactory portfolio management performance and test stock price distributions for these conditions. When the conditions apply, the algorithm eliminates the stock from portfolio consideration. Philosophically, this represents a decision to accept a lost opportunity rather than potentially make a losing investment. In some instances the algorithm's DISCARD EQUATION will eliminate LOCK-IN or LOCKOUT equations. Consequently, the LOCK-IN and LOCKOUT equations include the DISCARD EQUATION test as a condition for application.

DISCARD EQUATIONS adhere to the mathematical and logic formula:If (Vₘₐₓ)×((1.14×Rᵣₑₗₐₜᵢᵥₑ)−1)>=(0.14)×(FP+(2×Vₘᵢₙ)) and if (0.25)×((FP+2×Vₘᵢₙ))>=(Vₘₐₓ)×((1.25×Rᵣₑₗₐₜᵢᵥₑ)−1) then remove the stock from consideration.

This logic statement covers a wide range of stock prices, but only relates to the shape of the stock price distribution not current stock prices. Generally, price distributions of a short broad shape fall within this constraint and necessitate stock exclusion. The algorithm achieves the exclusion with several equations. The first equation makes the logic test. If the stock's price distribution characteristics fall within the logic test, the algorithm proceeds with additional equations equivalent to the equations in the LOCKOUT Equations. Initially, the algorithm sets zszrato equal to zero. The algorithm then enters another equation setting the allowed percentage of stock in the portfolio equal to zszrato minus the ratio of the amount invested in the stock relative to available invested funds. When the algorithm enters the final linear programming allocation of stock investment funds, any equation for a stock with zszrato equaling zero must set the stock investment to zero to meet the linear programming constraints prohibiting negative investment values. The algorithm, at Step 556, performs the final LP analysis utilizing all the constraint equations and then enters “4” at position “E3” on Sheet2 of “Stkanlzr”.

Stock Shorting Module

Before adjusting the simple LP layout and equations, the algorithm (FIG. 6, Step 654) challenges the user to use any basis or methodology to short sales in any of the selected stocks. For further explanation of the Stock Shorting algorithms to weigh shorting amounts within a trading range, review the paragraph above and substitute “Stkshortr” for “Stkanlzr” and add 100 to the step values.

For stock prices occurring above or below established trading ranges, the algorithm creates different equations that supersede the trading range equations. These additional equations reflect research on portfolio management results derived from the three previous blocks of analysis. The algorithm creates equations with three different formats:
lock the stock out of short sale,
lock the stock into the short sale or
discard consideration of the stock due to confusing stock price distribution results.

The algorithm prioritizes the non-trading range equations over trading range equations. These equations represent the logical antithesis to the LOCK-IN and LOCKOUT equations for the Portfolio Management Module. As the stock-shorting module provides risk reduction to the portfolio management module stocks conforming to a LOCKOUT of stock purchases should appear as logical candidates for short sales. Conversely, stocks conforming to purchase LOCK-IN conditions should find no purpose for short sales. Note the stock-shorting module evaluates the reasonableness of prices for good investments and determines shorting opportunities for over-priced stocks. This differs from the classic notion of short selling of “poor” investments.

For discussion purposes, variable names and symbols include: Current Stock Price=CP; Forecasted Stock Price=FP; Upper Forecasted Stock Price=UP ; Lower Forecasted Stock Price=P_{low}; Minimum Variability of Stock price (at the lower (0.68) set point=Vₘᵢₙ; Maximum Variability of Stock Price at the upper (0.95) set point=Vₘₐₓ; Ratio of the Variability of the Stock Price to the Variability of the Dow Jones Industrial Average=Rᵣₑₗₐₜᵢᵥₑ Note in the Stock Shorting Module: UP=FP+Vₘₐₓ and P_{low}=FP−Vₘₐₓ Although P_{low} remains the same in the two modules UP differs between them. The difference approximates a Poisson distribution of stock prices in stock purchases but a normal distribution of stock prices for short sales. LOCK-OUT EQUATIONS adhere to the mathematical and logic formula:If CP/(FP+(Vₘₐₓ×(1−Rᵣₑₗₐₜᵢᵥₑ))>=1.0288 force the stock from the portfolio. (Notice the similarity to the LOCK-OUT EQUATIONS in the portfolio management module except for a greater than rather than a less than logic comparison.)

Similarly to the portfolio management module, this algorithm also requires several programming equations to achieve the lockout. One equation evaluates the inequality to determine if the lock out applies. If it applies, a second equation sets an algorithm variable, zszrato, equal to zero. The algorithm then enters another equation setting the allowed percentage of stock in the portfolio equal to zszrato minus the ratio of the amount invested in the stock relative to available invested funds. When the algorithm enters the final linear programming allocation of stock investment funds, any equation for a stock with zszrato equaling zero must set the stock investment to zero to meet the linear programming constraints prohibiting negative investment values.

LOCK-IN EQUATIONS adhere to the mathematical and logic formula: When CP/FP<=0.9132 then include the stock in short sales. (Notice the similarity to the LOCK-IN EQUATIONS in the portfolio management module except for a less than rather than a greater than logic comparison.) A price decrease representing a differential between the current and forecasted prices of 8.68 percent within a one-week period indicates a major shift for a stock's price distribution. Similar to the portfolio management module this algorithm also requires several programming equations to achieve the lock-in. Consequently, the algorithm formulates several equations to force the stock into the shorting group. First, the algorithm evaluates the equation to determine if the logic statement applies. If it applies, a second equation evaluates a value for an algorithm variable, zdzrato. zdzrato equals the maximum permitted ratio of any stock within the available invested funds as selected by the user multiplied by the ratio derived by 0.8 divided by the square root of the number of stocks considered for shorting. The value of 0.8 represents a compromise value sanctioning shorting activity with 6 to 30 stocks. If the number of stocks considered for shorting were to exceed more than 30, the value 0.8 would have to increase.

A third equation determines if the value of zdzrato exceeds 0.05 and if so, sets zdzrato equal to 0.05. The algorithm then produces another equation equaling the ratio of the amount invested in the stock relative to available invested funds minus zdzrato. The reason for limiting the ratio of the shorted stock to the total of shorted funds to 0.05 represents a minimum lower bound of 5 percent of the portfolio. When the algorithm enters the final linear programming allocation of stock shorting funds, any equation for a stock with zdzrato equaling 0.05 must set the stock-shorting ratio to some value greater than or equal to 0.05 to meet the linear programming constraints prohibiting negative funds.

DISCARD EQUATIONS supersede all other algorithm equations. Portfolio research with the stock-shorting module indicates that under certain conditions the algorithm fails to adequately manage stock shorting activity. Consequently DISCARD EQUATIONS evaluate the conditions for unsatisfactory stock shorting performance and test stock price distributions for these conditions. When the conditions apply, the algorithm eliminates the stock from consideration for shorting. Philosophically, this represents a decision to accept a lost opportunity rather than potentially make a losing short sale. In some instances the algorithm's DISCARD EQUATION will eliminate LOCK-IN or LOCKOUT equations. Consequently, the LOCK-IN and LOCKOUT equations include the DISCARD EQUATION test as a condition for application.

DISCARD EQUATIONS adhere to the mathematical and logic formula:If (Vₘₐₓ)×((1.15×Rᵣₑₗₐₜᵢᵥₑ)−1)>=(0.15)×(FP+Vₘₐₓ) and if (0.25)×(FP+Vₘₐₓ)>=(Vₘₐₓ)×((1.25×Rᵣₑₗₐₜᵢᵥₑ)−1) then remove the stock from consideration.

This logic statement covers a wide range of stock prices but only relates to the shape of the stock price distribution not current stock prices. (Note that these discard equations differ from the Portfolio Management Module equations with slight differences in coefficients and (Vₘₐₓ) substituting for (2×Vₘᵢₙ) in parts of the equation. These differences occur because of using (UP=FP+Vₘᵢₙ) for the upper forecast in the Portfolio Management Module to approximate a Poisson Distribution.) Generally, price distributions of a short broad shape fall within this constraint and necessitate stock exclusion.

The algorithm achieves the exclusion with several equations. The first equation makes the logic test. If the stock's price distribution characteristics fall within the logic test, the algorithm proceeds with additional equations equivalent to the equations in the LOCKOUT Equations. Initially, the algorithm sets zszrato equal to zero. The algorithm then enters another equation setting the allowed percentage of stock in shorting funds equal to zszrato minus the ratio of the amount risked in the stock shorting relative to available shorting funds. When the algorithm enters the final linear programming allocation of stock shorting funds, any equation for a stock shorting with zszrato equaling zero must set the stock short to zero to meet the linear programming constraints prohibiting negative funds.

Solution Block 4

(FIG. 4, Steps 458 to End,
FIG. 5, Steps 558 to 564 and
FIG. 6, Steps 658 to 664)

Block 4 contains 2 distinct algorithms:

1) An algorithm reads the state of completion of the module at the initiation of the processing Block, marks the completion of the Block and counts variables;

2) An algorithm queries the user concerning the user's preference: on the marketing module for adjustment of the Marketing/Sales budget and, upon completing the budget, creating a Product Development and or Ingredient Substitution analysis spreadsheet; creating a permanent spreadsheet with adjustable investment and risk factors for the portfolio management module or stock shorting module.

Algorithms which Determine the Module's State of Completion and Count Inputs

Marketing Module

Step 458 examines “E3” on the spreadsheet, “Remake”, to locate a “4” in order to begin processing at Step 460. If Step 458 finds a value of “5” in “E3” it proceeds to Step 470 and exits the algorithm. At the conclusion of processing, Step 460 places a value of “4” in “E3” if the user declines to adjust the Marketing/Sales Budget. If the user adjusts the Marketing/Sales budget Step 468 places a value of “5” in “E3” and exits (Step 470). To determine the correct number of products, inventoried ingredients and non-inventoried ingredients an algorithm (FIG. 4. Step 458) searches for the term, “Products” on Sheet2 of the spreadsheet “Remake.” The algorithm after determining the location of the term “Products” adds one more row and then searches by counting columns to the right to find the bold italic term “Subtoot2.” The count to “Subtoot2” indicates the total number of ingredients plus one (1), including the two potential substitutes plus the marketing budget. After locating “Subtoot2” the algorithm returns to the column containing “Products” and searches by counting columns to the right and adding the number of columns containing plain italic characters. This total indicates the count of non-inventoried ingredients. The count of inventoried ingredients equals the total minus the non-inventoried count minus the two substitutes minus one (1) to allow for the marketing/sales budget.

Portfolio Management Module

To determine the state of completion of the module an algorithm (FIG. 5. Step 558) examines position “E3” on the spreadsheet, “Stkanlzr”. If it finds the value “4” at “E3” it queries the user if the user wishes to record the portfolio management results to a spreadsheet. If the user answers “Yes” the algorithm proceeds to Step 560. After a “Yes” answer, “Stkanlzr” seeks the spreadsheet “Foliomgr”. If “Stkanlzr” misses “Foliomgr” it asks the user to locate “Foliomgr” and then shuts down. If “Stkanlzr” locates “Foliomgr” at step 560 it saves its results to a spreadsheet called, “Foliomgr(date)” where date equates to the month and date of the analysis. After transferring results to “Foliomgr(date)”, the algorithm at step 562 deletes the results from “Foliomgr” and closes it. At step 564 the algorithm deletes results from “Stkanlzr” and closes it. If the user answers “No” at step 558, “Stkanlzr” proceeds to Step 570 and exits the module.

Another algorithm at this step, (FIG. 5. Step 558) calculates the number of stocks. The algorithm searches for the term, “Stock Symbol” on the module spreadsheet. After finding the term it adds 4 rows and begins character recognition of the fifth row and each succeeding row and counting the rows until it detects an empty row.

Stock Shorting Module

To determine the state of completion of the module an algorithm (FIG. 6, Step 658) examines position “E3” on the spreadsheet, “Stkshortr”. If it finds the value “4” at “E3” it queries the user if the user wishes to record the portfolio management results to a spreadsheet. If the user answers “Yes” the algorithm proceeds to Step 660. After a “Yes” answer, “Stkshortr” seeks the spreadsheet “Foliomgr”. If “Stkshortr” misses “Foliomgr,” it asks the user to locate “Foliomgr” and then shuts down. If “Stkshortr” locates “Foliomgr” it saves its results to a spreadsheet called, “Shrtfolio(date)” where date equates to the month and date of the analysis. After transferring results to “Shrtfolio(date)”, the algorithm at step 662 deletes the results from “Foliomgr” and closes it. At step 664 the algorithm deletes results from “Stkshortr” and closes it.

If the user answers “No” at step 658 “Stkshortr” proceeds to Step 670 and exits the module.

Another algorithm at this step, (FIG. 6, Step 658) calculates the number of stocks. The algorithm searches for the term, “Stock Symbol” on the module spreadsheet. After finding the term, it adds 4 rows, begins character recognition of the fifth row and each succeeding row, and counts the rows until it detects an empty row.

Algorithms Determining if and/or how the User Wishes to Complete the Solution Module

Marketing Module

An algorithm (Step 458) asks if the user wants to adjust the Marketing/Sales budget. If the user declines, the algorithm ends the program at step 470. If the user decides to adjust the marketing budget, the next algorithm (Step 460) focuses on the “detractor” products. Initially, the algorithm attempts to reduce the marketing/sales budget. The algorithm subtracts the “opportunity cost” determined by the LP Sensitivity Analysis from the user's original per-unit marketing/sales budget. The algorithm presents the calculation result to the user, along with an upper limit of the amount of the original budget. A subtraction greater than the original budget would create a negative number. The user can select (Step 462) any number between the suggested number and the lower bound. (If the “opportunity cost” exceeds the original budget, the user must raise the product's price to make it a “contributor.”) The algorithm performs the calculation and presents the results for each detractor product. After reviewing the budget adjustments, the algorithm (Step 464) then commands the LP solution technique to re-solve the LP. Assuming the user accepted the algorithm's recommendations for budget adjustments, the user is likely to achieve a dramatic Gross Margin improvement. Basically, the entire reduction in the marketing/sales budget flows directly to profitability. Furthermore, why should the business expend resources to sell something that ultimately decreases profitability? The algorithm (468) places a “5” in position “E3.” It queries the user concerning the desire to create a Product Development or Ingredient Substitution analysis spreadsheet. If the user indicates yes, the block searches for spreadsheet “PD&ISnlzr.” If the user has opened “PD&ISnlzr”, the marketing solution Module, “Remake” creates a specific marketing model on “PD&ISnlzr” that permits the user to: determine whether a new product development (Sheet2) will mesh economically with the existing business products or whether a potential new ingredient (Sheet3) will economically contribute to the existing mix of ingredients. This marketing model utilizes the equations formulated in Step 462 of Module “Remake” for adjusting the marketing budget that supports the existing product mix.

Sheet1 contains the product sales and statistical analysis data. At the conclusion of the creation of the new product-marketing model on “PD&ISnlzr”, “Remake” erases itself. If the user forgot to open spreadsheet, “PD&ISnlzr”, “Remake” sends an error message that it did not find “PD&ISnlzr”. The user has an opportunity to open “PD&ISnlzr”, have “Remake” locate a value of “5” at “E3”, and create the new product marketing model. Alternatively, the user can decline the Product Development or Ingredient Analysis until a later time.

Portfolio Management Module

If the algorithm (Step 558) locates a “4” at position “E3” of “Stkanlzr,” it queries the user if the user wishes a permanent copy of the portfolio analysis. If the user answers “Yes”, the algorithm goes to Step 560 and copies the results to a spreadsheet called “Foliomgr(date).” (See explanation in paragraphs above.) In Step 562, the algorithm erases itself and, in Step 564, closes “Stkanlzr.” Sheet1 contains the stock sales data and the statistical analysis results. Sheet2 contains the complete solution including the expert analysis constraint equations. Sheet3 contains a less sophisticated LP solution to compare with the Sheet2 results.

Stock Shorting Module

If the algorithm (Step 658) locates a “4” at position “E3” of “Stkshortr” it queries the user if the user wishes a permanent copy of the stock shorting analysis. If the user answers “Yes”, copies the results to a spreadsheet called “Foliomgr(date).” (See explanation in paragraphs above.) Sheet1 contains the stock sales data and the statistical analysis results. Sheet2 contains the complete solution including the expert analysis constraint equations. Sheet3 contains a less sophisticated LP solution to compare with the Sheet2 results.

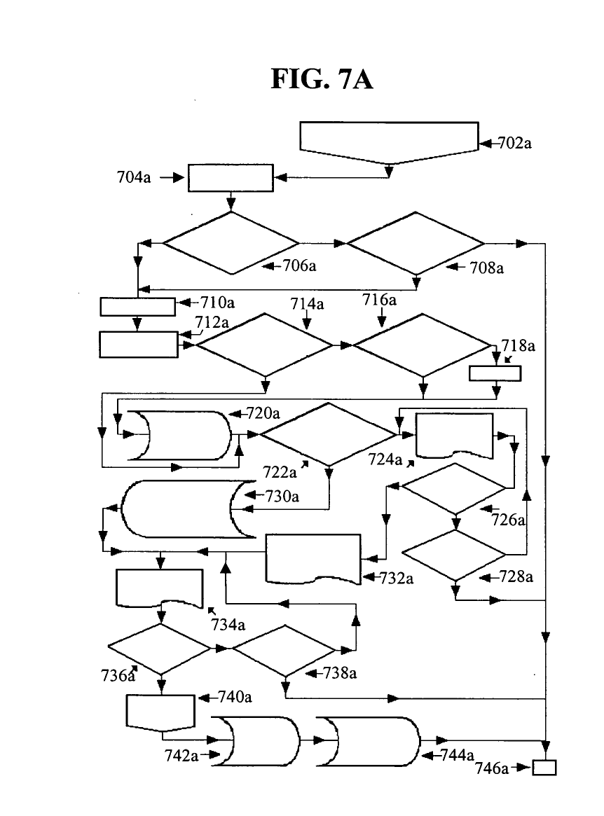

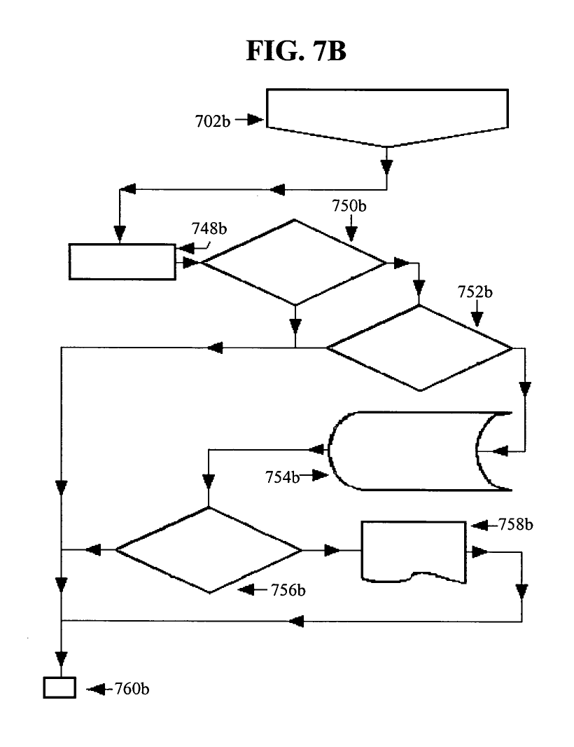

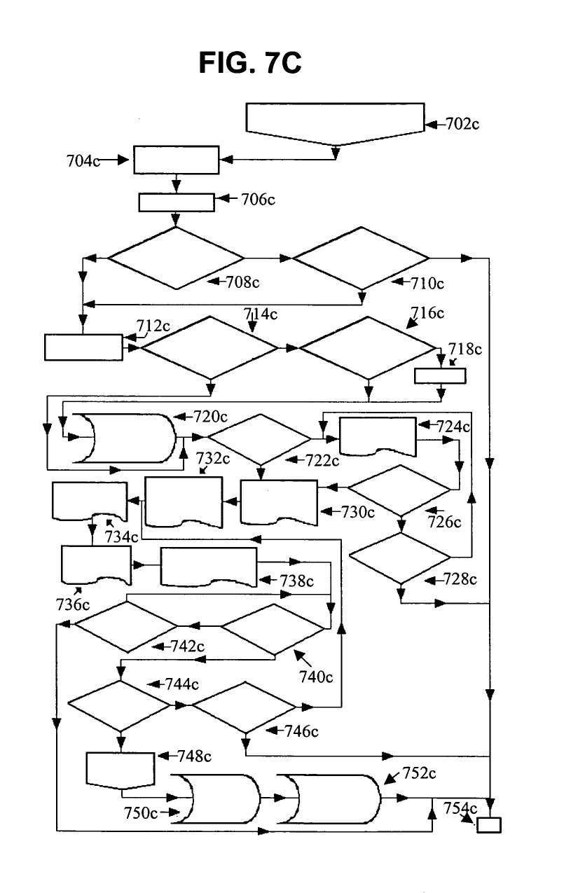

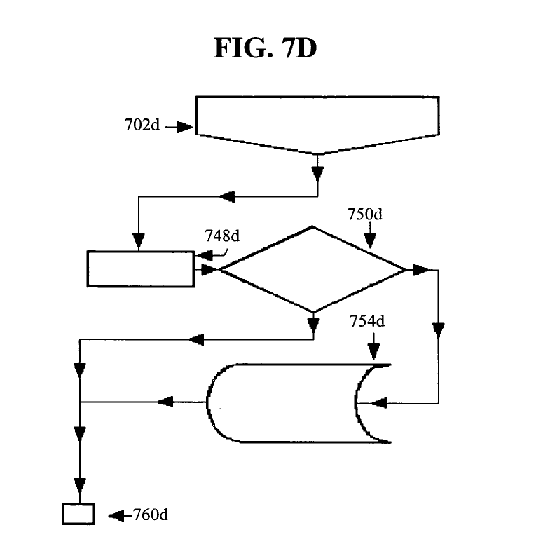

Flowchart Description of Sheet2 of PD&ISnlzr (Date) for Product Development (FIG. 7A)

PD&ISnlzr operates as a template for the Remake template spreadsheet. When the user requests a product development and or input substitution analysis, Remake calls PD&ISnlzr and transfers the spreadsheet data and algorithms to Sheet2 of PD&ISnlzr for a product development and Sheet3 for input substitution investigations. Remake then saves PD&ISnlzr as a finished spreadsheet called PD&ISnlzr(Date). Date indicates the month and day of PD&ISnlzr(Date)'s completion. Remake then closes PD&ISnlzr and itself so that Remake and PD&ISnlzr always remain empty templates for subsequent problem analysis. PD&ISnlzr contains the same algorithms described for PD&ISnlzr (Date).

Step 702a involves the selection and opening of Sheet2 of PD&ISnlzr(Date). On opening PD&ISnlzr(Date) inserts the current date at position Cell(4,4) on (Sheet2). This reference date provides a time marker to evaluate the timeliness and relevance upon subsequent openings to the date of spreadsheet completion recorded at Cells(3,4). Timeliness depends upon the time period of sales data: monthly, weekly or daily. If the date of the re-opening of a completed spreadsheet occurs within: 7 days for daily sales data, two weeks for weekly data or two months for monthly data, the algorithm continues to step 710a. If the re-opening date relative to the spreadsheet completion date exceeds: 8 days for daily sales data, two weeks for weekly data or two months for monthly data, the algorithm alerts the user at step 706a of the un-timeliness of the spreadsheet results, and asks, at Step 708a, whether the user wishes to continue using the out-dated results. If the user answers NO, the algorithm proceeds to step 746a, the algorithm exit.

If the user answers YES, the algorithm proceeds to step 710a and asks the user's name, assuming the user differs from the user of “Remake”. The algorithm proceeds to step 712a to read: Cells(1,1) for the number of products, Cells(2,1) for the number of inventoried ingredients, Cells(3,1) for the number of non-inventoried ingredients and Cells(6,1) for the type of product comparison, if any, the user attempted. Step 714a examines the spreadsheet to determine the existence of parameters in a spreadsheet storage area four lines below the spreadsheet layout. If stored parameters exist, the algorithm proceeds to step 722a. If no stored parameters exist, the algorithm at step 716a asks the user if the user wishes to hear instructions. If the user answers YES, the algorithm at step 718a calls a text-to-voice program.

Whatever the user's answer at step 718a, the algorithm proceeds to step 720a and moves the forecasted sales demand, ratios of ingredients to products and new product parameters to a storage area. At step 722a, the user has a choice between a general or specific product (or product market segment) comparisons. If the user chooses a general comparison (the algorithm recommends against this choice as a poor basis for comparison), the algorithm enters a 50 in Cells(6,1) and advances to step 730a. Step 730a determines the average product (or product market segment) price, average demand and average marketing/sales budget for all existing products (or product market segments). If the user selects a specific product (or product market segment) comparison as recommended by the algorithm at step 722a the algorithm moves to step 724a and asks the user to select a product for substitution. Step 724a asks if the user requires recapitulation of the status of each product as a contributor, non-contributor or neutral element in business profitability. If the user desires a recapitulation, the algorithm reviews the status of each product and inquires which product the user wishes to choose for product development substitution. If the user reviews all existing products without selecting one, step 726a moves to step 728a and asks the user whether to review the existing products again. If the user selects NO, the algorithm advances to step 746a, the algorithm exit.

If the user answers YES to step 728a, the algorithm returns to step 724a. Assuming upon return to step 726a, the user selects an existing product for substitution, and the algorithm at step 732a enters the sequence number of the product in the product list into Cells(6,1) and then obtains the selected product's (or product market segment) price, demand and marketing/sales budget and places the values in the appropriate cell locations for the new product. The algorithm advances to step 734a and requests the revised ratios of input requirements per unit of new product (or new product market segment) output.

After the user provides the revised ratios, the algorithm, at Step 736, compares the new ratios with the other ratios to determine if the user created a degeneracy problem between the new product and any of the existing products. If the user's proposed ingredient to product ratios creates a degeneracy problem, the algorithm advances to step 738a notifies the user of the degeneracy problem and asks if the user wishes to alter the new product ratios. If the user declines to adjust the ratios, the algorithm at step 738a notifies the user of the non-feasibility of problem solution and advances to step 746a, the algorithm exit.

If the user agrees to revise the ratios, the algorithm returns to step 734a to repeat the ratio input and subsequent degeneracy checking steps. Assuming elimination or non-occurrence of degeneracy, step 740a calls the linear program and step 742a solves the linear program for the proposed new product with the existing product parameters (price, demand and marketing/sales budget). Step 744a of the algorithm compares the new product solution to the existing product solution. The comparison includes several factors: Total Business Gross Margin, specific replaced product gross margin, and displacements of demand for non-contributor, contributor and neutral products.

Depending upon the comparison results, the algorithm indicates to the user whether the proposed product development improves or retards business performance and whether the proposal warrants further investigation. For example, if the proposed new product increases overall business gross margin, the gross margin for the substituted product and displaces demand for the substituted product as well as other non-contributor products, the algorithm notifies the user of the favorable results and recommends further investigation of the proposed product development. Conversely, if the proposed new product decreases Total Business Gross Margin and reduces product gross margin, as well as displacing demand for contributor products while not displacing demand for non-contributor products, the algorithm notifies the user of the objectionable results and recommends discontinuation of investigating the new product. After notifying the user of the new product results, step 746a exits the algorithm.

Flowchart Description for Sheet2 of PD&ISnlzr (Date) for Product Development (FIG. 7B): System Restore

After the user selects and opens Sheet2 of PD&ISnlzr (Date), pressing the Restart Button of Step 702b initiates the step 748b recovery of spreadsheet parameters. Step 748b includes reading Cells(2,1) for the number of inventoried ingredients, Cells(3,1) for the number of non-inventoried ingredients and Cells(6,1) for the type of product comparison, if any, the user previously attempted. If Cells(6,1) remains empty, the user has not attempted a product development and step 750b on finding an empty cell proceeds to step 760b and exits the program. If step 750b locates a number in Cells(6,1), the algorithm proceeds to step 752b to determine if any activity occurred at the new product ratio spreadsheet storage area. If no activity occurred the algorithm proceeds to step 760b and exits the program. If step 752b detects activity at the ratio storage area, the algorithm proceeds to step 754b and moves the original data concerning the existing products (or product marketing segments) to the appropriate cells on the solution spreadsheet. The algorithm advances to step 756b and checks Cells(6,1) to determine if the user sought a general (cell entry of 50) or specific product (cell entry of existing product sequence number) comparison. If step 756b detects a general comparison, the algorithm proceeds to step 760b and exits the program. If step 756b detects a specific comparison, the algorithm at step 758b restores the marketing/sales budget of the new product to the value of the comparison existing product's budget and then proceeds to step 760b and exits the program.

Flowchart Description for Sheet3 of PD&ISnlzr (Date) for Input Substitution

FIG. 7c, Step 702c involves the selection and opening Sheet3 of PD&ISnlzr (Date). On opening PD&ISnlzr(Date) at step 704c inserts the current date at position Cell(4,4) on (Sheet3). This reference date provides a time marker to evaluate the timeliness and relevance upon subsequent openings to the date of spreadsheet completion recorded at Cells(3,4). If the user opens Sheet3 of PD&ISnlzr (Date) on the same day as the Date in Cells(3,4) the algorithm assumes the user's name matches the name recorded during the creation of PD&ISnlzr(Date). Otherwise, the algorithm at step 706c asks for the user's name. Then, the algorithm investigates the timeliness of Sheet3. Timeliness depends upon the time period of sales data: monthly, weekly or daily. If the date of the re-opening of a completed spreadsheet occurs within: 7 days for daily sales data, two weeks for weekly data or two months for monthly data, the algorithm continues to step 712c. If the re-opening date relative to the spreadsheet completion date exceeds: 8 days for daily sales data, two weeks for weekly data or two months for monthly data, the algorithm alerts the user at step 708c of the un-timeliness of the spreadsheet results and proceeds to step 710c to ask if the user wishes whether to continue using the out-dated results. If the user answers no the algorithm proceeds to step 754c, the algorithm exit.

If the user answers yes, the algorithm proceeds to step 712c to read: Cells(1,1) for the number of products, Cells(2,1), for the number of inventoried ingredients, Cells(3,1), for the number of non-inventoried ingredients, Cells(6,1), for the number of the substituted ingredient, if one, and Cells(7,1) for the number of ingredient substitutions (either 1 or 2), if any, the user attempted. Step 714c examines the spreadsheet to determine the existence of parameters in a spreadsheet storage area. If stored parameters exist, the algorithm proceeds to step 722c. If no stored parameters exist, the algorithm at step 716c asks the user if the user wishes to hear instructions. If the user answers YES, the algorithm at step 718c calls a text to voice program. Whatever the user's answer at step 716c, the algorithm proceeds to step 720c and moves the forecasted sales demand, ratios of ingredients to products and ingredient prices to a storage area four lines below the spreadsheet layout.

At step 722c, the user has a choice between a new ingredient or, if previously selected, an existing ingredient for substitution investigation. If the user has previously selected an ingredient for a substitution comparison the algorithm queries whether to continue with the selected ingredient. If the user decides to continue with the existing ingredient, the algorithm proceeds to step 730c and enters the ingredient number (counted from left to right starting with one of the ingredient list in the spreadsheet layout) in Cells(6,1). If the user has not previously selected an ingredient or wishes to select another ingredient for substitution for that ingredient, Step 724c reviews the existing ingredients for the user's selection. The algorithm at step 726c checks if the user selected an ingredient, and if so proceeds to step 730c and enters the ingredient number in Cells(6,1). If the user failed to select an ingredient, step 726c advances to step 728c and asks the user about reviewing the ingredients again. If the user desires a re-capitulation, the algorithm returns to step 724c. If the user reviews all ingredients without selecting one or asking for another review, step 728c advances to step 754c, the algorithm exit.

Assuming the user selects an ingredient for substitution investigation, the algorithm at step 732c asks the user if ingredient substitution will require one or two substitute ingredients. Depending upon the user's choice, the algorithm enters a one or two in Cells(7,1) to remember the number of substitutes. The algorithm advances to step 734c and asks:

first, for the user to enter revised ratios of the amount of the existing ingredient required per unit of product (or product market segment) output and then checks the entered ratios and

second, the ratio(s) of the amount of the new ingredient(s) required per unit of product (or product market segment) output.

The algorithm advances to step 736c and asks the user to check the entered ratios. If upon checking, the user discovers an incorrect ratio entry, the user can correct the ratio. The algorithm advances to step 738c and asks the user for the price(s) for the new ingredient(s). Step 738c also assumes that the inventory of new substitute(s) equals the amount available of the existing ingredient and enters that amount in the appropriate cell for the substitute inventory. The algorithm advances to step 740c to determine if product (or product market segment) prices exceed the cost of product re-formulation with the new ingredients(s). If the product prices do not exceed the revised input costs, the algorithm advances to step 742c and cautions the user about the cost discrepancy and asks if the user wishes to increase the product price to cover input cost. If the user declines to adjust the product (or product market segment) price, the algorithm advances to step 754c, the algorithm exit. If the user accepts a product price adjustment the algorithm makes the adjustment advances through step 740c to step 744c.

If the product prices at step 740c cover input costs or the user accepts a price adjustment to cover input costs, the algorithm advances to step 744c and checks if degeneracy occurs from the ingredient changes. If degeneracy does occur the algorithm advances to step 746c and asks the user if the user wishes to redo the ratios of substitute ingredient amounts per unit of product (or product market segment) output. If the user answers YES, the algorithm returns to step 734c; if NO, the algorithm advances to step 754c, the algorithm exit. Assuming no degeneracy, the algorithm calls the linear program at step 748c and solves the linear program at step 750c.

Step 752c evaluates the new ingredient solution. The evaluation includes several factors: Total Business Gross Margin, and displacements of existing ingredients in products (or product market segments) and displacement of contributor products (or product market segments) from the marketing mix. Depending upon the comparison results, the algorithm indicates to the user whether the proposed ingredient substitution improves or retards business performance and whether the proposal warrants further investigation. For example, if the proposed new ingredient increases overall business gross margin, displaces usage for the substituted ingredient without affecting contributor products' role in the marketing mix, the algorithm notifies the user of the favorable results and recommends further investigation of the proposed ingredient substitution. Conversely, if the proposed new ingredient decreases Total Business Gross Margin, marginally replaces usage of the substituted ingredient and displaces contributor products' role in the marketing mix, the algorithm notifies the user of the objectionable results and recommends discontinuation of investigating the new ingredient. After notifying the user of the new ingredient results, step 754c exits the algorithm.

Flowchart Description for Sheet3 of PD&ISnlzr (Date) for Input Substitution FIG. 7D; System Restore

After the user selects and opens Sheet3 of PD&ISnlzr (Date), pressing the Restart Button of Step 702d initiates the step 748d recovery of spreadsheet parameters. Step 748d includes reading Cells(2,1) for the number of inventoried ingredients, Cells(3,1) for the number of non-inventoried ingredients and Cells(6,1) for the type of input substitution comparison, if any, the user previously attempted. If Cells(6,1) remains empty, the user has not attempted an ingredient substitution and step 750d on finding an empty cell proceeds to step 760d and exits the program. If step 750d locates a number in Cells(6,1), the algorithm proceeds to step 754d and moves the original data concerning the existing products (or product marketing segments) to the appropriate cells on the solution spreadsheet, resets the ratio data for Subtoot1 and Subtoot2 to zero and any adjusted product prices to their original values. The algorithm advances to step 760d and exits the program.

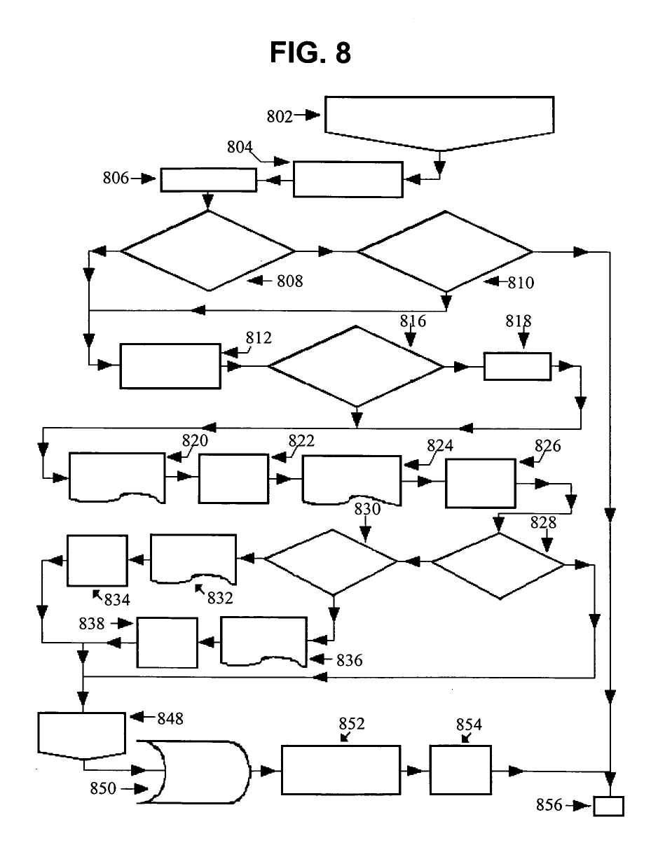

Flowchart Description for Sheet2 of Foliomgr (Date) for Portfolio Management of Stocks & Sheet2 of Shrtfolio (Date); (FIG. 8)

Foliomgr operates as a template for both the Stkanlzr and Stkshortr template spreadsheets. Whether the user conducts a portfolio management or stock shorting analysis, the user opens Foliomgr. When the user reaches completion of either the Stkanlzr or Stkshortr templates each template calls Foliomgr and transfers algorithms, stock price data to Sheet1 and spreadsheet layout to Sheet2 of Foliomgr. Stkanlzr then saves Foliomgr as a finished spreadsheet called Foliomgr(Date). Date indicates the month and day of Foliomgr(Date)'s completion. Stkanlzr then closes Foliomgr and itself so that Stkanlzr and Foliomgr always remain empty templates for subsequent problem analysis. The Foliomgr algorithm description applies to Foliomgr(Date).

Stkshortr saves Foliomgr as a finished spreadsheet called Shrtfolio(Date). Date indicates the month and day of Shrtfolio(Date)'s completion. Stkshortr then closes Foliomgr and itself so that Stkshortr and Foliomgr always remain empty templates for subsequent problem analysis. Foliomgr contains the same algorithm described for Shrtfolio(Date) and Foliomgr(Date).

Step 802 involves selection of either a Shrtfolio(Date) or Foliomgr(Date) and initiation of an investigation of: changing total capital investment, tolerance for loss and or dividend requirements. Upon initiation, the algorithm proceeds to step 804 to place the date of the analysis in Cells(4,4) and compare the current date with the date of the stock shorting or portfolio management analysis recorded in Cells(3,4). The algorithm proceeds to step 806 and if the time difference exceeds more than one day, the algorithm asks the user for a user name. For a time difference of less than one day, the algorithm assumes the user's name to be the name of the Foliomgr(Date) or Shrtfolio(Date) user recorded in Cells(3,3) and proceeds to step 808.

If the time difference exceeds 7 days, the algorithm proceeds to step 810 and notifies the user of the outdated nature of the analysis and whether the user wishes to continue. If the user declines to continue, the algorithm proceeds to step 856 and ends. If the user wishes to continue, the algorithm proceeds to step 812. For a time difference at step 808 of less than 7 days, the algorithm assumes timeliness of the analysis and proceeds to step 812. Step 812 recovers the number of stocks recorded on either Foliomgr(Date)'s or Shrtfolio(Date)'s Cells(1,1) of Sheet2. The algorithm proceeds to step 816 and asks the user if the user wishes to hear subsequent instructions as well as read them. If the user answers YES, the algorithm at step 818 calls a text-to-voice program. The algorithm then proceeds to step 820 and asks if the user wishes to change the amount of investment capital used in the original analysis and if so what amount to use. The algorithm moves to step 822 and asks the user to confirm or adjust the entry made at step 820. The algorithm at step 824 asks the user whether the user's tolerance for potential investment losses has changed from the tolerance expressed in the original analysis and if so to adjust the amount. At step 826, the algorithm asks the user to confirm or change the entry made at step 824.

At step 828, the algorithm checks whether the spreadsheet data indicate that any stocks pay dividends. If no stocks pay dividends, the algorithm proceeds to step 848. If some stocks pay dividends, the algorithm proceeds to step 830 to determine the type of analysis the user desires. If the algorithm detects the words “Optimum Short Mix” the algorithm determines the user desires a review of a stock shorting analysis and warns the user to anticipate the possibility of paying stock dividends on borrowed stock shares. If the algorithm detects the words “Optimum Portfolio,” the algorithm determines the user desires a review of a stock portfolio analysis and warns the user that the selection of a minimum dividend payment can place a restrictive constraint on the portfolio analysis. If the algorithm detects a stock shorting analysis, it proceeds to step 836 to ask the user about the maximum dividend repayment the user will consider. The algorithm suggests a maximum percentage based on a value determined by: (the total dividends paid by all dividend paying stocks) multiplied by (the total number of stocks) and (divided by the sum of all stock prices). The user may elect to increase or decrease the algorithm recommended value. At step 838, the algorithm asks the user to confirm or adjust the entry made at step 836.

If the algorithm at step 830 detects the words “Optimum Portfolio,” the algorithm determines the user desires a review of a stock portfolio and proceeds to step 832 and asks about the minimum dividend re-payment required by the user. The algorithm suggests a minimum percentage based on a value determined by: (the total dividends paid by all dividend paying stocks) multiplied by (the total number of stocks) and (divided by the sum of all stock prices). The user may elect to increase or decrease the algorithm recommended value. At step 834, the algorithm asks the user to confirm or adjust the entry made at step 832.

Whether the user provides a minimum dividend requirement for a portfolio management problem or a maximum dividend re-payment for a stock shorting problem, the algorithm proceeds to step 848 and calls the linear program. At step 850, the algorithm solves the linear program. The algorithm advances to step 852 and, for each stock, counts the number of times the historic stock price data falls outside the range of the calculated price distribution for the stock. If the calculated stock price distribution accurately reflects stock price data indicating a trading range pattern, no more than 5 percent of the 36 weeks of price data (0.05×36=1.8 or 2 above in addition to 2 below) should fall above or below the 95-percentile range of the calculated values. Therefore, more than 4 instances of stock prices outside the 95-percentile range of calculated prices indicates the calculated distribution may poorly reflect a stock with prices observing trading range behavior.

Step changes in price occur for a stock facing re-evaluations in value with either value increases or value decreases. Based on stock price research, some stocks can enter periods with more volatile trading ranges. Therefore, the algorithm contains a threshold value of 9 prices outside the upper or lower 95-percentile range. If the algorithm counts more than 9 instances of prices on the outside or downside of the 95-percentile limit for a stock included in the optimum solution mix, the algorithm at step 854 issues a warning to the user that a statistical problem may exist. This cautionary note should instigate the user to more closely investigate the stock price history to determine:
Did the user enter incorrect price data for the stock?
Did the stock's price change with an unusually large increase or decrease during certain periods?
If unusual price changes occurred, can the user understand and justify the changes and adjust the price history to reflect the reasons for the stock valuation?
If the user understands that unusual stock prices stem either from incorrect data or price re-evaluations, the user should correct the price data and re-do the entire solution procedure. Otherwise, the user will have erroneous solution results based on incorrect or inappropriate stock price data. After warning the user of possible statistical problems, the algorithm ends at step 856. If no potential statistical problem exists, the algorithm proceeds from step 852 to step 856 and ends.

As people familiar with the linear programming and management arts will appreciate, the problem-solving methods described above are usable in a variety of contexts, so the invention is not limited to the specific examples described. Rather, the scope of the invention is defined by the following claims.

What is claimed is:

1. A method of generating, using a computer, advice to a human being for evaluation of results of linear programming (LP) calculations, comprising the steps of:
first, evaluating a basis solution of Linear Programming (LP) equations representing a base list of items analyzed, using a sensitivity analysis associated with this basis solution to determine opportunity costs such that the basis solution alters to reflect input changes from opportunity costs;
second, storing a predetermined number of values which, if included during calculation of said basis solution, would have resulted in a solution differing, by a predetermined percentage, from said basis solution;
third, selecting certain of said values as input variables for a further round of linear program calculations, performing said LP calculations, and storing a revised solution;
fourth, evaluating results of a plurality of revised solutions, each representing a different plurality of starting items, and determining which revised solutions are better, in terms of predefined criteria; and
fifth, identifying, to the human being, those items whose inclusion in the calculations lead to such better revised solutions.

2. A method of acquiring data, for later analysis, concerning a plurality of products to be offered by a company, comprising the steps of:
prompting a user to select (208) between entering data manually and entering data from a pre-existing data file and, upon selection of the former, prompting said user (250) for a product name and estimated product demand for each of said plurality of products;
upon selection of entry of data from a pre-existing data file, obtaining (218) from said user, an identification of said pre-existing data file,
confirming (220) that the identified data file contains product demand numbers for a predetermined plurality of time periods,
confirming (224) that the identified data file contains data for a number of products falling within a predetermined acceptable product number range,
transferring (234) said product names, product demand numbers and time periods into an input data file adapted for input into linear programming equations of a linear programming computer program,
and saving (240) said input data file for subsequent use.

3. A method of formulating, from input data concerning a plurality of products, ratios for use in linear programming analysis of business problems, comprising the steps of
locating a pre-existing data file containing data concerning said plurality of products;
confirming (344) that said data file contains data spanning a predetermined number of time periods, for each product among said plurality of products;
confirming (346) that said data file contains data concerning at least a predetermined number of products;
locating (348) or creating (350) a respective ingredient data file representing ingredients needed to produce each product;
checking (354) each ingredient data file to confirm that a count of ingredients in said ingredient data file is within a predetermined acceptable range; and
generating (358) a ratio data file representing relative costs of said product ingredients, with respect to total cost of each product.

4. A method of optimizing product offerings of a company for maximum profitability, based upon data representing product ingredient costs and product market segment demand, comprising the steps of:
acquiring (408) product sales history data by product market segment;
checking (412) said acquired data for consistency;
performing (416) statistical analysis on said acquired data in order to derive variability-values;
forecasting (418) demand for each of a plurality of products, including use of said variability values to define a demand range for each product;
defining (420) linear programming variables for execution of a linear optimization program, including a set of initial demand constraints;
executing (436) said linear optimization program and thereby determining price and gross margin sensitivity for each product market segment;
iterating (448) execution of said linear optimization program for upper and lower prices for each product market segment;
revising (452) said demand constraints and re-executing said linear program using said revised demand constraints, and
outputting recommended product prices and marketing budgets for each of said products, based upon results of said linear program.

5. A method of selecting and managing a portfolio consisting of an initial cash fund and a plurality of stocks, comprising the steps of
selecting (504) a plurality of stocks which are candidates for inclusion in said portfolio;
acquiring (508) historical time-series data on each of said candidate stocks and at least one index of stocks listed on a securities exchange;
calculating (518) a variability parameter for each of said stocks and each index;
sorting (520) said stocks by variability, relative to each index;
calculating (528) an expected risk/reward ratio for each stock;
generating (530), for each stock, a plurality of linear program (LP) equations and constraint values used in said LP equations;
executing (534) said linear program equations a first time, to thereby calculate a respective price sensitivity of each stock and a respective probability that taking a position in said stock will be profitable;
repeating (548) execution of said linear program equations, substituting, for each stock price, price values which are higher and lower by a predetermined factor;
adjusting (554) said constraint values and executing (556) said linear program equations again with said adjusted constraint values; and
recording (560) results of said calculations as a spreadsheet.

6. The method of claim 5, wherein said at least one index of stocks includes a first exchange index representing Dow Jones Average (DJA) stocks and a second exchange index representing Standard & Poor's 500 stocks (SPY).

7. The method of claim 6, further comprising inputting data concerning an index representing NASDAQ 100 stocks (QQQ).

8. The method of claim 5, wherein said plurality of linear program equations comprise, for each stock:
an equation representing total reward from appreciation,
an equation representing total dividends;
an equation representing total potential loss;
an equation representing stock price variability; and
and an objective function equation which is a sum of said total appreciation and total dividends equations.

9. The method of claim 5, further comprising
performing a sensitivity analysis for each stock, namely simulating a hypothetical stock price increase and a hypothetical stock price decrease, determining whether the stock remains among those stocks having the most favorable risk/reward ratios for stock transactions within a trading range, and
outputting a result of said determination to a user, to permit said user to decide whether to retain said stock in the portfolio.

10. A computer-assisted method of managing a portfolio of a plurality of investment positions, comprising the steps of:
inputting data (802-836) concerning a current date, an amount to be invested, a tolerance for loss, and any dividend constraint on desired results from said portfolio;
executing (850) linear program equations to calculate a price distribution, with respect to a plurality of successive dates, for each investment position;
determining (852) how often, over said plurality of dates, a price of each investment position falls outside respective upper and lower limits of a trading range; and
for each one of said investment positions whose price falls outside said trading range more often than a predetermined criterion, issuing (854) a warning with respect to said range-exceeding investment position.

11. A method of managing a portfolio of short positions in stocks, comprising the steps of
selecting (604) a plurality of stocks which are candidates for inclusion in said portfolio;
acquiring (608) historical time-series data on each of said candidate stocks and at least one index of stocks listed on a securities exchange;
calculating (618) a variability parameter for each of said stocks and each index;
sorting (620) said stocks by variability, relative to each index;
calculating (628) an expected risk/reward ratio for each stock;
generating (630), for each stock, a plurality of linear program (LP) equations and constraint values used in said LP equations;
executing (634) said linear program equations a first time, to thereby calculate a respective price sensitivity of each stock and a respective probability that taking a position in said stock will be profitable;
repeating (648) execution of said linear program equations, substituting, for each stock price, price values which are higher and lower by a predetermined factor;
adjusting (654) said constraint values and executing (656) said linear program equations again with said adjusted constraint values; and
recording (660) results of said calculations as a spreadsheet.

12. The method of claim 4, further comprising performing a product development/input substitution analysis by the steps of creating (702) a spreadsheet, associated with an initial date, representing a plurality of products, a plurality of inventoried product ingredients, a plurality of
non-inventoried product ingredients, and
a type of product comparison desired to be performed;
defining, for each product, values representing how much of said ingredients are required to make each unit of product;
periodically inputting (708) sales data for each of said plurality of products until data, representing a desired time interval, are complete;
calculating (730) in a linear program, for each product, average product price, average demand and average marketing budget over said desired time interval, results of said calculations collectively constituting an initial Product Solution; and
generating, for each product, an indication of whether said product contributes to business profitability, detracts from business profitability, or has a neutral effect on business profitability.

13. The method of claim 12, further comprising the steps of selecting one of said plurality of products in a previous product list for replacement on said product list;
calculating a revised Product Solution; and
comparing (744) said revised Product Solution with said initial Product Solution in terms of business gross margin, replaced product gross margin and displacements of demand for contributor, non-contributor and neutral ones of said products.

14. The method of claim 12, further comprising the step of testing (736) whether presence of a new product on said list creates a degeneracy with respect to any product already on said list.

15. The method according to claim 12, further comprising the steps of
selecting (702b) a spreadsheet of existing product data;
reading (748b, 750b) predetermined cells of said spreadsheet to determine whether said data document an attempt at product development and, if not, terminating program execution;
testing (756b) whether said attempt at product development was a specific product comparison and, if so, restoring (758b) marketing budget values in said spreadsheet to values which were present, prior to said specific product comparison.

16. The method according to claim 12, further comprising the steps of
selecting (702c) a spreadsheet of existing product data;
reading (712c, 714c) predetermined cells of said spreadsheet to determine whether said data document an attempt at product substitution and, if not, prompting a user to select a product for substitution;
prompting (732) a user to input data concerning amounts of previous ingredients and amounts of new ingredients required per unit of product;
comparing (740c) product price with aggregate cost of ingredients according to a proposed reformulation and, if unprofitable, prompting (742c) said user to increase said product price or modify said proposed reformulation.

17. The method according to claim 16, further comprising the step of checking whether said proposed reformulation creates a degeneracy.

18. The method according to claim 17, further comprising performing linear program calculations (750c) to determine how the proposed reformulation affects business profitability.

19. A method of generating, using a computer, advice to a human being for evaluation of results of linear programming (LP) calculations, comprising the steps of:
first, evaluating a basis solution of Linear Programming (LP) equations representing a base list of items analyzed, using a sensitivity analysis associated with this basis solution to determine trigger price adjustments such that the basis solution alters to reflect input changes from trigger price adjustments;
second, storing a predetermined number of values which, if included during calculation of said basis solution, would have resulted in a solution differing, by a predetermined percentage, from said basis solution;
third, selecting certain of said values as input variables for a further round of linear program calculations, performing said LP calculations, and storing a revised solution;
fourth, evaluating results of a plurality of revised solutions, each representing a different plurality of starting items, and determining which revised solutions are better, in terms of predefined criteria; and
fifth, identifying, to the human being, those items whose inclusion in the calculations lead to such better revised solutions.
